(19) United States
(12) Patent Application Publication
(10) Pub. No.: US 2009/0002358 A1
(43) Pub. Date: Jan. 1, 2009

(54) SOURCE DRIVER, ELECTRO-OPTICAL DEVICE, PROJECTION-TYPE DISPLAY DEVICE, AND ELECTRONIC INSTRUMENT

(75) Inventor: Tsuyoshi Tamura, Suwagun Haramura (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/147,148

(22) Filed: Jun. 26, 2008

(30) Foreign Application Priority Data
Jun. 29, 2007 (JP) 2007-172042

(51) Int. Cl. G06F 3/038

(52) U.S. Cl. 345/212

(57) ABSTRACT

A source driver that drives a source line of an electro-optical device includes an image data comparison circuit that compares K-bit (K is an integer equal to or larger than two) image data in a current drive period with preceding data corresponding to a preceding drive level, and an amplifier circuit that drives the source line based on the image data with a first current drive capability, and then drives the source line based on the image data with a second current drive capability that is lower than the first current drive capability within a given drive period. When the image data comparison circuit has detected that higher-order L bits (L<K, L is a natural number) of the image data coincide with higher-order L bits of the preceding data, the amplifier circuit drives the source line with the second current drive capability without driving the source line with the first current drive capability within the drive period.

Japanese Patent Application No. 2007-172042 filed on Jun. 29, 2007, is hereby incorporated by reference in its entirety.

### BACKGROUND OF THE INVENTION

The present invention relates to a source driver, an electro-optical device, a projection-type display device, an electronic instrument, and the like.

As a liquid crystal panel (display panel in a broad sense; electro-optical device in a broader sense) used for electronic instruments, an active matrix type liquid crystal panel using a switch element such as a thin film transistor (hereinafter abbreviated as “TFT”) has been known. In JP-A-2005-250353, JP-A-2006-72124, and JP-A-2006-53252, the output from an amplifier that drives a source line of a liquid crystal panel is switched to the output from a digital-to-analog converter (DAC) that outputs an analog voltage to the amplifier, or the slew rate of the amplifier is changed in order to drive the liquid crystal panel with low power consumption.

An amorphous silicon liquid crystal panel or a low-temperature polysilicon liquid crystal panel has been widely used as a liquid crystal panel. For example, a projector utilizing a liquid crystal panel has been desired to display high-definition television (HDTV) image data. Therefore, a high-temperature polysilicon liquid crystal panel that enables an increase in processing speed has been employed in such a field. A source driver that drives such a liquid crystal panel must quickly write a voltage into a pixel electrode corresponding to the amount of high-definition image data.

When giving priority to image quality (e.g., when employing the high-definition standard), it is desirable to use a dot inversion method as a polarity inversion drive method when using an active matrix type liquid crystal panel having a TFT. When using the dot inversion method, since a common electrode voltage must be fixed, differing from the line inversion method or the like, the amplitude of the voltage applied to the source line from the source driver must be increased. Therefore, an amplifier of the source driver that drives the source line consumes a large amount of power Accordingly, it has been desired to quickly and accurately drive the source line while reducing the power consumption of the source driver.

### SUMMARY

According to one aspect of the invention, there is provided a source driver that drives a source line of an electro-optical device, the source driver comprising:

an image data comparison circuit that compares K-bit (K is an integer equal to or larger than two) image data in a current drive period with preceding data corresponding to a preceding drive level; and

an amplifier circuit that drives the source line based on the image data with a first current drive capability, and then drives the source line based on the image data with a second current drive capability that is lower than the first current drive capability within a given drive period,
when the image data comparison circuit has detected that higher-order L bits (L<K, L is a natural number) of the image data coincide with higher-order L bits of the preceding data, the amplifier circuit driving the source line with the second current drive capability without driving the source line with the first current drive capability within the drive period; and

when the image data comparison circuit has detected that the higher-order L bits of the image data do not coincide with the higher-order L bits of the preceding data, the amplifier circuit driving the source line with the first current drive capability and then driving the source line with the second current drive capability within the drive period.

According to another aspect of the invention, there is provided an electro-optical device comprising the above source driver.

According to another aspect of the invention, there is provided a projection-type display device comprising the above source driver.

According to another aspect of the invention, there is provided an electronic instrument comprising the above source driver.

### BRIEF DESCRIPTION OF THE SEVERAL VIEWS OF THE DRAWING

FIG. 1 is a view showing an outline of the configuration of a liquid crystal device according to one embodiment of the invention.

FIG. 2 is a view showing an outline of another configuration of a liquid crystal device according to one embodiment of the invention.

FIG. 3 is a block diagram showing a configuration example of a gate driver shown in FIG. 1.

FIG. 4 is a fundamental configuration diagram showing a source driver according to one embodiment of the invention.

FIG. 5 is a view showing a waveform example of a source output voltage during multiplex drive.

FIG. 6 is a block diagram showing a detailed configuration example of a source driver shown in FIG. 1 or 2.

FIG. 7 is a block diagram showing a configuration example of the source driver shown in FIG. 6 corresponding to one source output.

FIG. 8 is a timing diagram showing an operation example of a multiplexer and a comparison circuit shown in FIG. 7.

FIG. 9 is a view illustrative of grayscale data compared by a comparison circuit.

FIG. 10 is a view illustrative of the operation of a comparison circuit.

FIGS. 11A and 11B are views illustrative of examples of a timing signal.

FIG. 12 is a circuit diagram showing a configuration example of an s amplifier control circuit.

FIG. 13 is a circuit diagram showing a configuration example of an output circuit.

FIG. 14 is a circuit diagram showing a configuration example of a demultiplexer of an LCD panel.

FIG. 15 is a view illustrative of the operation of a demultiplexer shown in FIG. 14.

FIG. 16 is a timing diagram showing an operation example of a source driver according to one embodiment of the invention.

FIG. 17 is a view showing an example of a source output of a source driver within one selection period shown in FIG. 16.

FIG. 18 is a view showing an example of a change in current consumption of an output circuit shown in FIG. 13 with the passage of time.

FIG. 19 is a block diagram showing a configuration example of a source driver according to a first modification corresponding to one source output.

FIG. 20 is a view illustrative of the operation of a comparison circuit according to a first modification.

FIGS. 21A and 21B are views illustrative of examples of timing signals.

FIG. 22 is a circuit diagram showing a configuration example of an amplifier control circuit according to the first modification.

FIG. 23 is a block diagram showing a configuration example of a source driver according to a second modification corresponding to one source output.

FIG. 24 is a view showing the main portion of the configuration of a source output according to a third modification.

FIG. 25 is a block diagram showing a configuration example of a source driver according to a fourth modification.

FIG. 26 is a block diagram showing a configuration example of a projection-type display device according to one embodiment of the invention.

FIG. 27 is a schematic configuration diagram showing the main portion of the projection-type display device shown in FIG. 26.

FIG. 28 is a block diagram of a configuration example of a portable telephone according to one embodiment of the invention.

### DETAILED DESCRIPTION OF THE EMBODIMENT

Several aspects of the invention may provide a source driver that quickly drives a source line with low power consumption, an electro-optical device including the source driver, a projection-type display device, and an electronic instrument.

According to one embodiment of the invention, there is provided a source driver that drives a source line of an electro-optical device, the source driver comprising:

an image data comparison circuit that compares K-bit (K is an integer equal to or larger than two) image data in a current drive period with preceding data corresponding to a preceding drive level; and

an amplifier circuit that drives the source line based on the image data with a first current drive capability, and then drives the source line based on the image data with a second current drive capability that is lower than the first current drive capability within a given drive period,

when the image data comparison circuit has detected that higher-order L bits (L<K, L is a natural number) of the image data coincide with higher-order L bits of the preceding data, the amplifier circuit driving the source line with the second current drive capability without driving the source line with the first current drive capability within the drive period; and

when the image data comparison circuit has detected that the higher-order L bits of the image data do not coincide with the higher-order L bits of the preceding data, the amplifier circuit driving the source line with the first current drive capability and then driving the source line with the second current drive capability within the drive period.

In this embodiment, when the amplifier circuit can drive the source line with at least two current drive capabilities, the current drive capability is changed based on the comparison result of the image data comparison circuit. Since a change in potential of the source line (i.e., the difference between the image data and the preceding data) is determined to be small when the image data comparison circuit has detected that the higher-order L bits of the image data coincide with the higher-order L bits of the preceding data, the amplifier circuit drives the source line with the second current drive capability without driving the source line with the first current drive capability that consumes a large amount of current. Since a change in potential of the source line (i.e., the difference between the image data and the preceding data) is determined to be large when the image data comparison circuit has detected that the higher-order L bits of the image data do not coincide with the higher-order L bits of the preceding data, the amplifier circuit drives the source line with the first current drive capability that consumes a large amount of current, but quickly changes the potential of the source line, and then drives the source line with the second current drive capability. According to this embodiment, since the source line is not driven with a high current drive capability when a change in potential of the source line is small, differing from the case of uniformly controlling the current drive capability, ringing can be suppressed while reducing unnecessary power consumption. Moreover, since only the higher-order L bits are compared, the above-mentioned effect can be achieved by the image data comparison circuit that suppresses an increase in circuit scale.

In the source driver,

when the image data comparison circuit has detected that higher-order p bits (L<p<K, p is a natural number) of the image data coincide with higher-order p bits of the preceding data, the amplifier circuit may drive the source line with the first current drive capability for a reduced period of time, and then may drive the source line with the second current drive capability.

According to this embodiment, since the period in which the source line is driven with the first current drive capability is reduced, the potential of the source line can be finely controlled without increasing the number of current drive capabilities of the amplifier circuit, while achieving the above-described effect. Moreover, since the period in which the source line is driven with the first current drive capability is reduced on condition that the higher-order p bits coincide, the potential of the source line can be quickly set with low current consumption even if a change in potential is small.

In the source driver,

when performing multiplex drive that drives a plurality of the source lines based on time-division multiplexed image data, the image data comparison circuit may compare an average value of the time-division multiplexed image data with the preceding data instead of the image data;

when the image data comparison circuit has detected that the higher-order L bits of the image data coincide with the higher-order L bits of the preceding data, the amplifier circuit may drive the source line with the second current drive capability without driving the source line with the first current drive capability within the drive period; and

when the image data comparison circuit has detected that the higher-order L bits of the average value do not coincide with the higher-order L bits of the preceding data, the amplifier circuit may drive the source line with the first current drive capability and then may drive the source line with the second current drive capability within the drive period.

In the source driver,

when the image data comparison circuit has detected that higher-order p bits (L<p<K, p is a natural number) of the average value coincide with higher-order p bits of the preceding data, the amplifier circuit may drive the source line with the first current drive capability for a reduced period of time, and then may drive the source line with the second current drive capability.

According to this embodiment, since whether or not to change the current drive capabilibty is determined using the average value of the time-division multiplexed image data, the image data need not be compared at each time-division timing of the time-division multiplexed image data, while achieving the above-described effect. Therefore, power consumption can be further reduced.

In the source driver,

the amplifier circuit may drive the source line based on the image data with a third current drive capability that is lower than the first current drive capability and is higher than the second current drive capability; and

the amplifier circuit may drive the source line based on the image data with the first current drive capability, then may drive the source line based on the image data with the third current drive capability, and then may drive the source line based on the image data with the second current drive capability.

In the source driver, the preceding data may be data that corresponds to a precharge potential of the source line.

According to this embodiment, an electro-optical device can be provided to which a source driver that quickly drives a source line with low power consumption is applied.

According to another embodiment of the invention, there is provided an electro-optical device comprising:

a plurality of gate lines;

a plurality of source lines;

a plurality of pixels, each of the plurality of pixels being specified by a corresponding gate line among the plurality of gate lines and a corresponding source line among the plurality of source lines;

a gate driver that scans the plurality of gate lines; and

one of the above source drivers that drives the plurality of source lines.

According to another embodiment of the invention, there is provided an electro-optical device comprising one of the above source drivers.

According to this embodiment, a projection-type display device can be provided to which a source driver that quickly drives a source line with low power consumption is applied.

According to another embodiment of the invention, there is provided a projection-type display device comprising:

the above electro-optical device;

a light source that emits light that enters the electro-optical device; and

projection means that projects light emitted from the electro-optical device.

According to another embodiment of the invention, there is provided a projection-type display device comprising one of the above source drivers.

According to another embodiment of the invention, there is provided an electronic instrument comprising the above electro-optical device.

According to another embodiment of the invention, there is provided an electronic instrument comprising:

the above electro-optical device; and

means that supplies image data to the electro-optical device.

According to another embodiment of the invention, there is provided an electronic instrument comprising one of the above source drivers.

According to this embodiment, an electronic instrument can be provided to which a source driver that quickly drives a source line with low power consumption is applied.

Embodiments of the invention are described in detail below with reference to the drawings. Note that the embodiments described below do not in any way limit the scope of the invention laid out in the claims. Note that all elements of the embodiments described below should not necessarily be taken as essential requirements for the invention.

1. Liquid Crystal Device

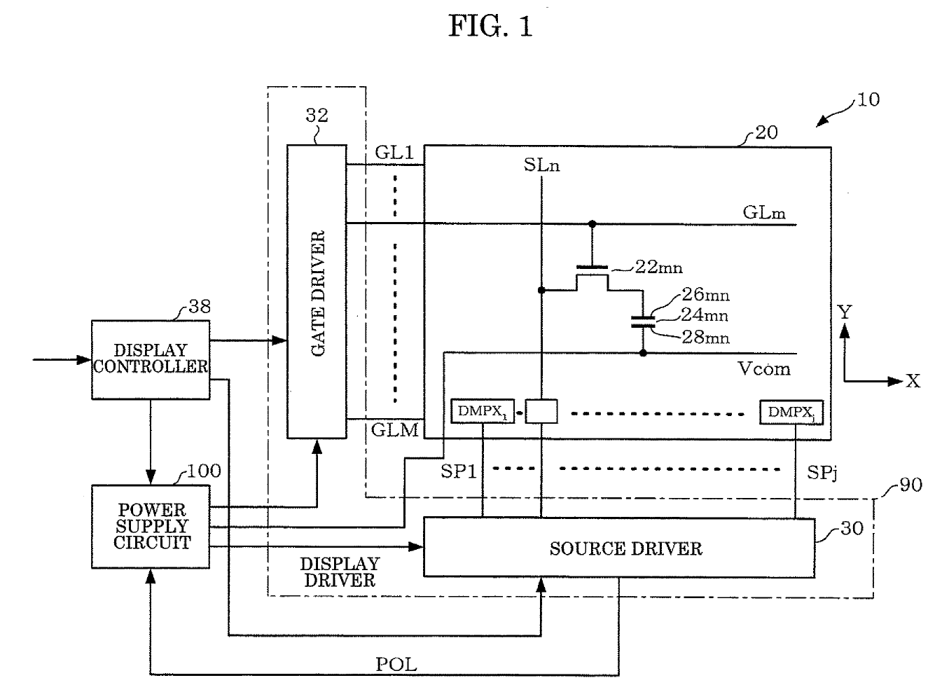

FIG. 1 schematically shows the configuration of an active matrix type liquid crystal device according to one embodiment of the invention. Although the following description focuses on an active matrix type liquid crystal device, a source driver according to this embodiment may also be applied to other liquid crystal devices.

The following description illustrates an example in which a liquid crystal display panel of a liquid crystal device is driven by multiplex drive. Note that the invention may also be applied to the case where the liquid crystal display panel is driven normally (i.e., non-multiplex drive). The term “multiplex drive” refers to a drive method in which drive signals corresponding to a plurality of source lines are time-division multiplexed and output to each output. The term “non-multiplex drive” refers to a drive method in which a drive signal corresponding to each source line is output to each output.

A liquid crystal device 10 includes a liquid crystal display (LCD) panel (display panel in a broad sense; electro-optical device in a broader sense) 20. The LCD panel 20 is a high-temperature polysilicon liquid crystal panel. The LCD panel 20 is formed on a glass substrate, for example. A plurality of gate lines (scan lines) GL1 to GLM (M is an integer equal to or larger than two), arranged in a direction Y and extending in a direction X, and a plurality of source lines (data lines) SL1 to SLN (N is an integer equal to or larger than two), arranged in the direction X and extending in the direction Y, are disposed on the glass substrate. The LCD panel 20 includes demultiplexers DMPX₁ to DMPXⱼ (j is an integer equal to or larger than two) provided corresponding to the source lines. The LCD panel 20 separates a source output from a source driver, and outputs a drive voltage to each of the source lines SL1 to SLN.

A pixel area (pixel) is provided corresponding to the intersection of the gate line GLm (1≦m≦M, m is an integer; hereinafter the same) and the source line SLn (1≦n≦N, n is an integer; hereinafter the same). A thin film transistor (hereinafter abbreviated as “TFT”) 22mn is disposed in the pixel area.

The gate of the TFT 22mn is connected to the gate line GLm. The source of the TFT 22mn is connected to the source line SLn. The drain of the TFT 22mn is connected to a pixel electrode 26mn. A liquid crystal (electro-optical element in a broad sense) is sealed between the pixel electrode 26mn and a common electrode 28mn opposite to the pixel electrode 26mn so that a liquid crystal capacitor (liquid crystal element in a broad sense) 24mn is formed. The transmissivity of the pixel changes corresponding to the voltage applied between the pixel electrode 26mn and the common electrode 28mn. A common electrode voltage Vcom is supplied to the common electrode 29mn.

The LCD panel 20 is formed by bonding a first substrate provided with the pixel electrode and the TFT and a second substrate provided with the common electrode, and sealing a liquid crystal (electro-optical material) between the first and second substrates, for example.

Therefore, the LCD panel 20 includes a pixel electrode connected to a source line through a TFT as a switch element. In other words, the LCD panel 20 includes a plurality of source lines, a plurality of switch elements, and a plurality of pixel electrodes, each of the pixel electrodes being connected to a source line among the plurality of source lines through a switch element among the plurality of switch elements.

The liquid crystal device 10 includes a display driver (driver circuit in a broad sense) 90 that drives the LCD panel 20. The display driver 90 includes a source driver 30. The source driver 30 multiplex-drives the source lines SL1 to SLN of the LCD panel 20 based on image data (grayscale data) corresponding to each source line. Specifically, the source driver 30 time-division multiplexes drive voltages output to a plurality of source lines, and outputs the multiplexed drive voltages to source voltage supply lines SP₁ to SPⱼ. The demultiplexer of the LCD panel 20 connected to the corresponding source voltage supply line separates the multiplexed drive voltages supplied from the source voltage supply line at a separation timing designated by the source driver 30, and supplies the separated drive voltages to a plurality of source lines. In FIG. 1, the demultiplexers are included in the LCD panel 20. Note that the source driver 30 may include the demultiplexers DMPX₁ to DMPXⱼ.

The display driver 90 may include a gate driver (scan driver in a broad sense) 32. The gate driver 32 scans the gate lines GL1 to GLM of the LCD panel 20 within one vertical scan period. The display driver 90 may have a configuration in which at least one of the source driver 30 and the gate driver 32 is omitted.

The liquid crystal device 10 may include a power supply circuit 100. The power supply circuit 100 generates voltages necessary for driving the source lines, and supplies the generated voltages to the source driver 30. For example, the power supply circuit 100 generates power supply voltages VDDH and VSSH necessary for the source driver 30 to drive the source lines, and voltages necessary for a logic section of the source driver 30.

The power supply circuit 100 also generates voltages necessary for scanning the gate lines, and supplies the generated voltages to the gate driver 32.

The power supply circuit 100 also generates the common electrode voltage Vcom. The power supply circuit 100 outputs the common electrode voltage Vcom to the common electrode of the LCD panel 20. The common electrode voltage Vcom is periodically set at a high-potential-side voltage VCOMH and a low-potential-side voltage VCOML in synchronization with the timing of a polarity inversion signal POL generated by the source driver 30.

The liquid crystal device 10 may include a display controller 38. The display controller 38 controls the source driver 30, the gate driver 32, and the power supply circuit 100 according to information set by a host (not shown) such as a central processing unit (hereinafter abbreviated as “CPU”). For example, the display controller 38 sets the operation mode of the source driver 30 and the gate driver 32, and supplies a vertical synchronization signal and a horizontal synchronization signal generated therein to the source driver 30 and the gate driver 32.

In FIG. 1, the liquid crystal device 10 includes the power supply circuit 100 and the display controller 38. Note that at least one of the power supply circuit 100 and the display controller 38 may be provided outside the liquid crystal device 10. The liquid crystal device 10 may include the host.

The source driver 30 may include at least one of the gate driver 32 and the power supply circuit 100.

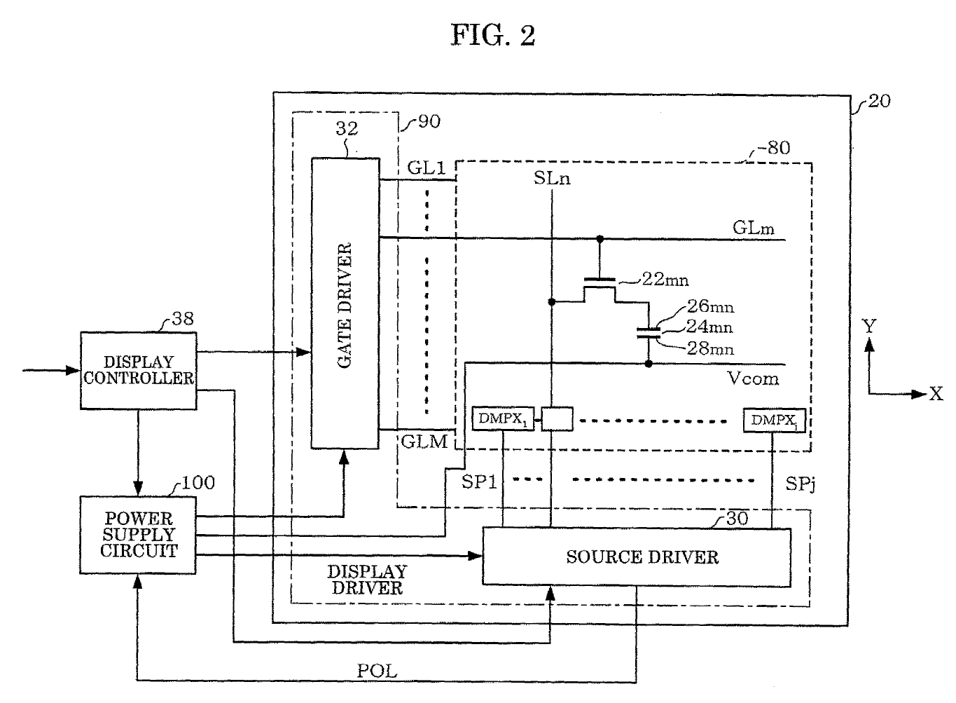

Some or all of the source driver 30, the gate driver 32, the display controller 38, and the power supply circuit 100 may be formed on the LCD panel 20. In FIG. 2, the display driver 90 (source driver 30 and gate driver 32) is formed on the LCD panel 20, for example. Specifically, the LCD panel 20 may include a plurality of source lines, a plurality of gate lines, a plurality of switch elements, each of the plurality of switch elements being connected to a gate line among the plurality of gate lines and a source line among the plurality of source lines, and a source driver that drives the plurality of source lines. A plurality of pixels are formed in a pixel formation area 80 of the LCD panel 20.

2. Gate Driver

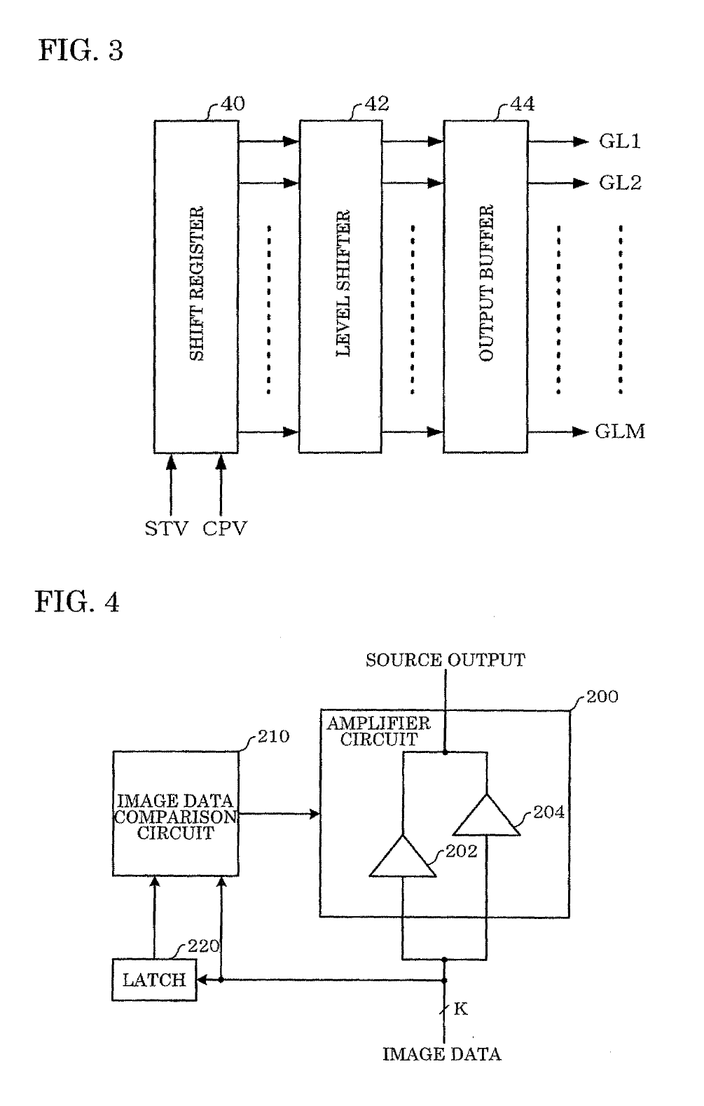

FIG. 3 shows a configuration example of the gate driver 32 shown in FIG. 1.

The gate driver 32 includes a shift register 40, a level shifter 42, and an output buffer 44.

The shift register 40 includes a plurality of flip-flops provided corresponding to the gate lines and connected sequentially. The shift register 40 holds a start pulse signal STV in the flip-flop in synchronization with a clock signal CPV, and sequentially shifts the start pulse signal STV to the adjacent flip-flops in synchronization with the clock signal CPV. The clock signal CPV is a horizontal synchronization signal (HSYNC), and the start pulse signal STV is a vertical synchronization signal (VSYNC).

The level shifter 42 shifts the level of the voltage input from the shift register 40 to a voltage level corresponding to the liquid crystal element of the LCD panel 20 and the transistor performance of the TFT.

The output buffer 44 buffers a scan voltage shifted by the level shifter 42, and outputs the scan voltage to the gate line to drive the gate line. The high-potential-side voltage of the pulsed scan voltage is a select voltage, and the low-potential-side voltage of the pulsed scan voltage is an unselect voltage.

The gate driver 32 may scan the gate lines by selecting a gate line corresponding to a decoding result of an address decoder instead of scanning the gate lines using the shift register, differing from FIG. 3.

3. Source Driver

3.1 Outline of Configuration

FIG. 4 is a fundamental configuration diagram showing the source driver 30 according to this embodiment.

FIG. 4 shows the configuration of the source driver 30 corresponding to one output. The source driver 30 includes an amplifier circuit 200 that drives the source line based on K-bit (K is an integer equal to or larger than two) image data, and an image data comparison circuit 210. The image data comparison circuit 210 compares K-bit image data in the current drive period with preceding data corresponding to a preceding drive level. The source driver 30 includes a latch 220 in order to hold the preceding data. The term “drive period” refers to one selection period (1SEL) in which one of the source lines is selected during multiplex drive, or one horizontal scan period (1H) during non-multiplex drive.

The amplifier circuit 200 drives the source line based on image data with a first current drive capability, and then drives the source line based on the image data with a second current drive capability that is lower than the first current drive capability within a given drive period. The amplifier circuit 200 drives the source line while changing the current drive capability based on the comparison result of the image data comparison circuit 210. The amplifier circuit 200 includes a first amplifier 202 for driving the source line with the first current drive capability, and a second amplifier 204 for driving the source line with the second current drive capability.

Specifically, when the image data comparison circuit 210 has detected that the higher-order L bits (L<K, L is a natural number) of the image data coincide with the higher-order L bits of the preceding data, the amplifier circuit 200 drives the source line with the second current drive capability in the drive period without driving the source line with the first current drive capability. When the image data comparison circuit 210 has detected that the higher-order L bits of the image data do not coincide with the higher-order L bits of the preceding data. The amplifier circuit 200 drives the source line with the first current drive capability and then drives the source line with the second current drive capability within the drive period.

The potential of the source line can be quickly changed by driving the source line with a high current drive capability. The potential of the source line can be set with high accuracy by then driving the source line with a low current drive capability.

In FIG. 4, the amplifier circuit 200 drives the source line with two current drive capabilities. Note that the amplifier circuit 200 may drive the source line with three or more current drive capabilities.

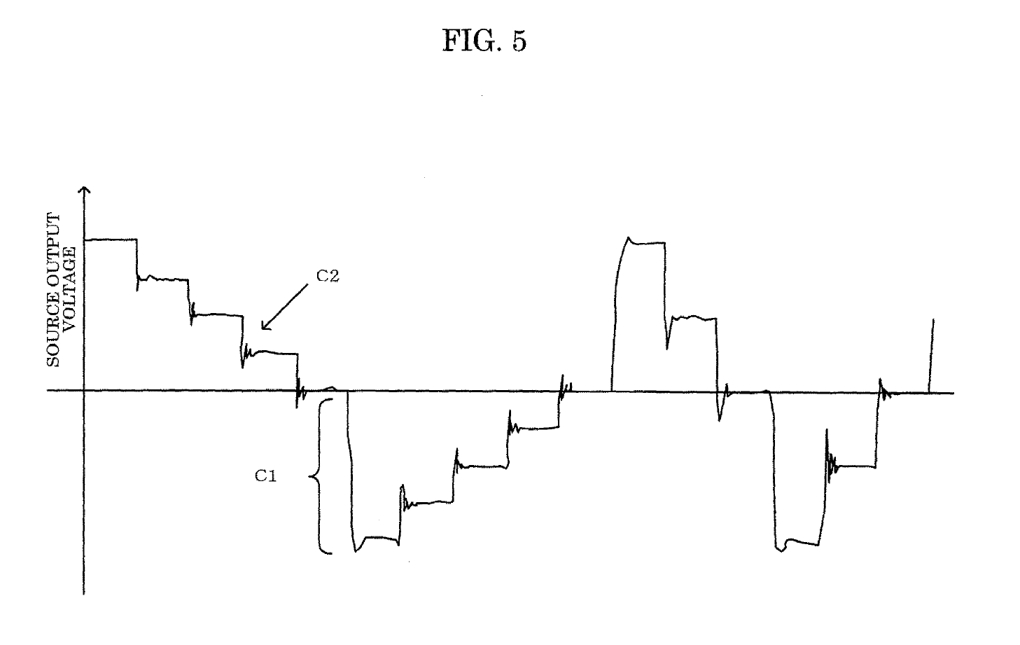

FIG. 5 shows a waveform example of a source output voltage during multiplex drive.

In FIG. 5, the vertical axis indicates voltage, and the horizontal axis indicates time. The source output voltage (drive voltage) changes corresponding to each selection period (SEL period) during multiplex drive. The level of the source output voltage in each selection period corresponds to the image data (grayscale data). The current drive capability of the amplifier circuit 200 is determined so that the potential of the source line quickly changes when a change in the source output voltage is a maximum (C1). If the amplifier circuit 200 drives the source line with a high current drive capability even when a change in the source output voltage is small, ringing occurs. Moreover, power is unnecessarily consumed.

According to this embodiment, the image data comparison circuit 210 detects whether or not the higher-order L bits of the image data coincide with the higher-order L bits of the preceding data, and the amplifier circuit 200 drives the source line with a low current drive capability when the image data comparison circuit 210 has detected that the higher-order L bits of the image data coincide with the higher-order L bits of the preceding data. Since the difference in image data corresponding to the source output voltage is determined to be small when the image data comparison circuit 210 has detected that the higher-order L bits of the image data coincide with the higher-order L bits of the preceding data, the amplifier circuit 200 drives the source line with the second current drive capability without driving the source line with the first current drive capability that consumes a large amount of current. The difference in image data corresponding to the source output voltage is determined to be large when the image data comparison circuit 210 has detected that the higher-order L bits of the image data do not coincide with the higher-order L bits of the preceding data, and the amplifier circuit 200 drives the source line with the first current drive capability that consumes a large amount of current, and then drives the source line with the second current drive capability.

This suppresses ringing while reducing unnecessary power consumption. Moreover, since all bits need not be compared, the image data can be compared with the preceding data by a simple configuration.

3.2 Detailed Configuration Example

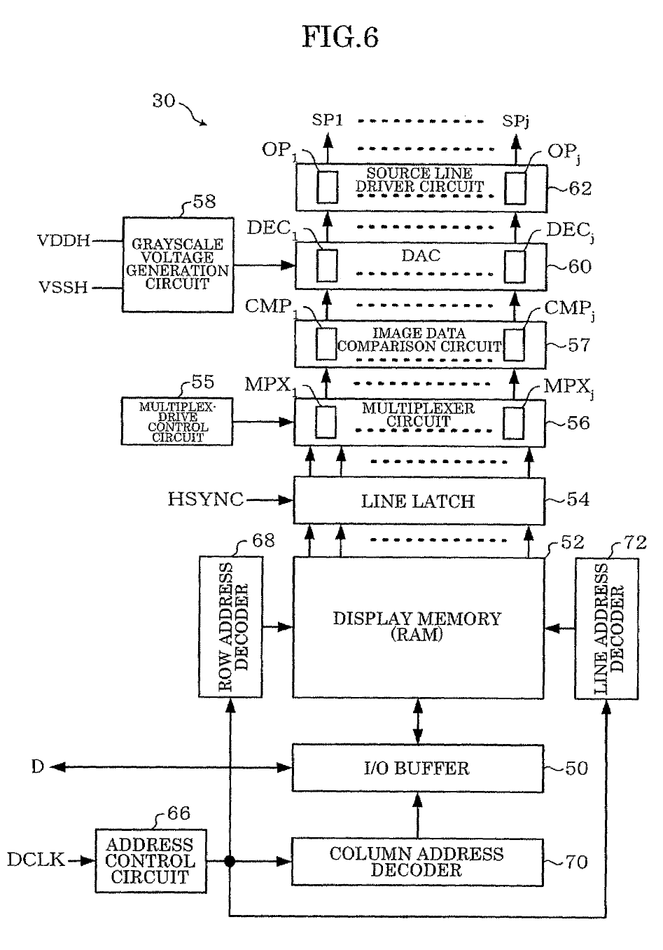

FIG. 6 shows a detailed configuration example of the source driver 30 shown in FIG. 1 or 2.

In FIG. 6, the source driver 30 drives the source line (source voltage supply line) with three current drive capabilities. FIG. 6 shows a configuration example of the source driver 30 that multiplex-drives the LCD panel 20 including the demultiplexers. Note that the source driver 30 may normally drive the LCD panel 20. In FIG. 6, the source driver 30 includes a display memory. Note that the source driver 30 may be configured to capture grayscale data using a shift register and latch the grayscale data in a latch every horizontal scan period, instead of providing a display memory.

The source driver 30 includes an I/O buffer 50, a display memory 52, a line latch 54, a multiplex-drive control circuit 55, a multiplexer circuit 56, an image data comparison circuit 57, a grayscale voltage generation circuit 58, a digital/analog converter (DAC) 60, and a source line driver circuit 62.

For example, grayscale data D (image data) is input to the source driver 30 from the display controller 38. The grayscale data D is input in synchronization with a dot clock signal DCLK, and is buffered by the I/O buffer 50. The dot clock signal DCLK is supplied from the display controller 38.

The display controller 38 or the host (not shown) accesses the I/O buffer 50. The grayscale data buffered by the I/O buffer 50 is written into the display memory 52. The grayscale data read from the display memory 52 is buffered by the I/O buffer 50 and then output to the display controller 38 and the like.

The display memory 52 includes a plurality of memory cells provided corresponding to output lines connected to the source lines. Each memory cell is specified by a row address and a column address. The memory cells corresponding to one scan line are specified by a line address.

An address control circuit 66 generates the row address, the column address, and the line address which specify the memory cell in the display memory 52. The address control circuit 66 generates the row address and the column address when writing the grayscale data into the display memory 52. Specifically, the grayscale data buffered by the I/O buffer 50 is written into the memory cell of the display memory 52 specified by the row address and the column address.

A row address decoder 68 decodes the row address, and selects the memory cells of the display memory 52 corresponding to the row address. A column address decoder 70 decodes the column address, and selects the memory cells of the display memory 52 corresponding to the column address.

The address control circuit 66 generates the line address when reading the grayscale data from the display memory 52 and outputting the grayscale data to the line latch 54. Specifically, a line address decoder 72 decodes the line address, and selects the memory cells of the display memory 52 corresponding to the line address. The grayscale data corresponding to one horizontal scan read from the memory cells specified by the line address is output to the line latch 54.

The address control circuit 66 generates the row address and the column address when reading the grayscale data from the display memory 52 and outputting the grayscale data to the I/O buffer 50. Specifically, the grayscale data stored in the memory cell of the display memory 52 specified by the row address and the column address is read into the I/O buffer 50. The grayscale data read into the I/O buffer 50 is acquired by the display controller 38 or the host (not shown).

Therefore, the row address decoder 68, the column address decoder 70, and the address control circuit 66 shown in FIG. 6 function as a write control circuit that controls writing of the grayscale data into the display memory 52. The line address decoder 72, the column address decoder 70, and the address control circuit 66 shown in FIG. 6 function as a read control circuit that controls reading of the grayscale data from the display memory 52.

The line latch 54 latches the grayscale data corresponding to one horizontal scan read from the display memory 52 at a change timing of the horizontal synchronization signal HSYNC (latch pulse LP) that specifies one horizontal scan period. The line latch 54 includes a plurality of registers, each of the registers storing the grayscale data corresponding to one dot. The grayscale data corresponding to one dot read from the display memory 52 is stored in each register of the line latch 54.

The multiplex-drive control circuit 55 generates a multiplex control signal for time-division multiplexing the grayscale data corresponding to each source line.

The multiplexer circuit 56 includes multiplexers MPX₁ to MPXⱼ. Each multiplexer generates multiplexed data by time-division multiplexing the grayscale data corresponding to one horizontal scan latched by the line latch 54 based on the multiplex control signal in units of k (k is a positive integer; k×j=N) source outputs.

The image data comparison circuit 57 includes comparison circuits CMP₁ to CMPⱼ. Each comparison circuit compares image data in the current drive period with preceding data corresponding to the preceding drive level. Specifically, each comparison circuit compares the higher-order L bits of the K-bit image data with the higher-order L bits of the preceding data The image data comparison circuit 57 has the function of the image data comparison circuit 210 shown in FIG. 4.

The grayscale voltage generation circuit 58 generates a plurality of grayscale voltages (reference voltages) corresponding to the grayscale data. Specifically, the grayscale voltage generation circuit 58 generates the grayscale voltages corresponding to the grayscale data based on a high-potential-side power supply voltage VDDH and a low-potential-side power supply voltage VSSH.

The DAC 60 generates the grayscale voltage corresponding to the grayscale data multiplexed into the multiplexed data from each multiplexer of the multiplexer circuit 56 corresponding to each source output. Specifically, the DAC 60 selects the grayscale voltage corresponding to each piece of grayscale data multiplexed into the multiplexed data from the image data comparison circuit 57 or each multiplexer of the multiplexer circuit 56 from the grayscale voltages generated by the grayscale voltage generation circuit 58, and outputs the selected grayscale voltage as a multiplexed grayscale voltage. The DAC 60 includes voltage select circuits DEC₁ to DECⱼ provided corresponding to the source outputs. Each voltage select circuit outputs one grayscale voltage corresponding to the grayscale data of the multiplexed data from the grayscale voltages from the grayscale voltage generation circuit 58.

The source line driver circuit 62 includes output circuits OP₁ to OPⱼ. Each of the output circuits OP₁ to OPⱼ includes a voltage-follower-connected operational amplifier. Each output circuit performs impedance conversion using the multiplexed grayscale voltage from each voltage select circuit of the DAC 60, and drives its output. The output circuit OP₁ has the function of the amplifier circuit 200 shown in FIG. 4.

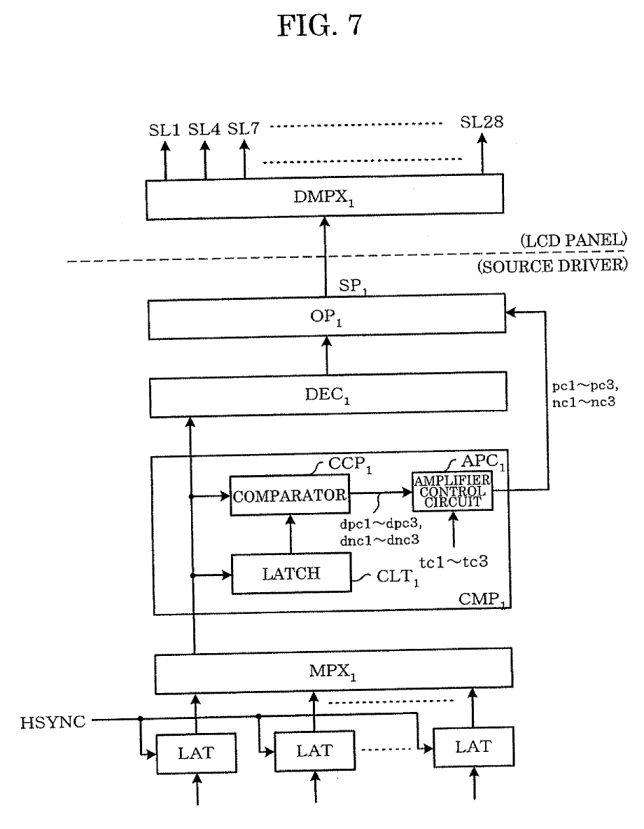

FIG. 7 is a block diagram showing a configuration example of the source driver 30 shown in FIG, 6 corresponding to one source output. 101151 FIG. 7 shows a configuration example of the source driver 30 corresponding to one source output when performing 10-multiplex drive. As shown in FIG. 7, when the grayscale data has been latched by each latch in synchronization with the horizontal synchronization signal HSYNC, the grayscale data corresponding to 10 dots is time-division multiplexed by the multiplexer MPX1 based on the multiplex control signal.

The comparison circuit CMP, includes a latch CLT₁, a comparator CCP₁, and an amplifier control circuit APC₁. The latch CLT₁ latches the grayscale data time-division multiplexed by the multiplexer MPX₁ every selection period specified by the multiplex control signal. Specifically, the data latched by the latch CLT1 is updated every selection period. The comparator CCP₁ detects whether or not the higher-order L bits of the grayscale data time-division multiplexed by the multiplexer MPX₁ coincide with the higher-order L bits of the grayscale data latched by the latch CLT₁ every selection period specified by the multiplex control signal. The comparator CCP₁ outputs control signals dpc1 to dpc3 and dnc1 to dnc3 based on the comparison result.

The amplifier control circuit APC₁ generates control signals pc1 to pc3 and ne1 to nc3 that change the current drive capability of the output circuit OP₁ using the control signals dpc1 to dpc3 and dnc1 to dnc3.

The voltage select circuit DEC₁ selects the grayscale voltage corresponding to the time-division multiplexed grayscale data, and outputs the selected grayscake voltage.

The output circuit OP₁ drives the source voltage supply line SP₁ with a current drive capability that changes based on the control signals pe1 to pc3 and nc1 to nc3 from the amplifier control circuit APC₁ of the comparison circuit CMP₁.

The demultiplexer DMPX₁ provided in the LCD panel 20 and connected to the source voltage supply line SP1 supplies the drive voltage to the source lines SL1, SL4, SL7, . . . , and SL2S8.

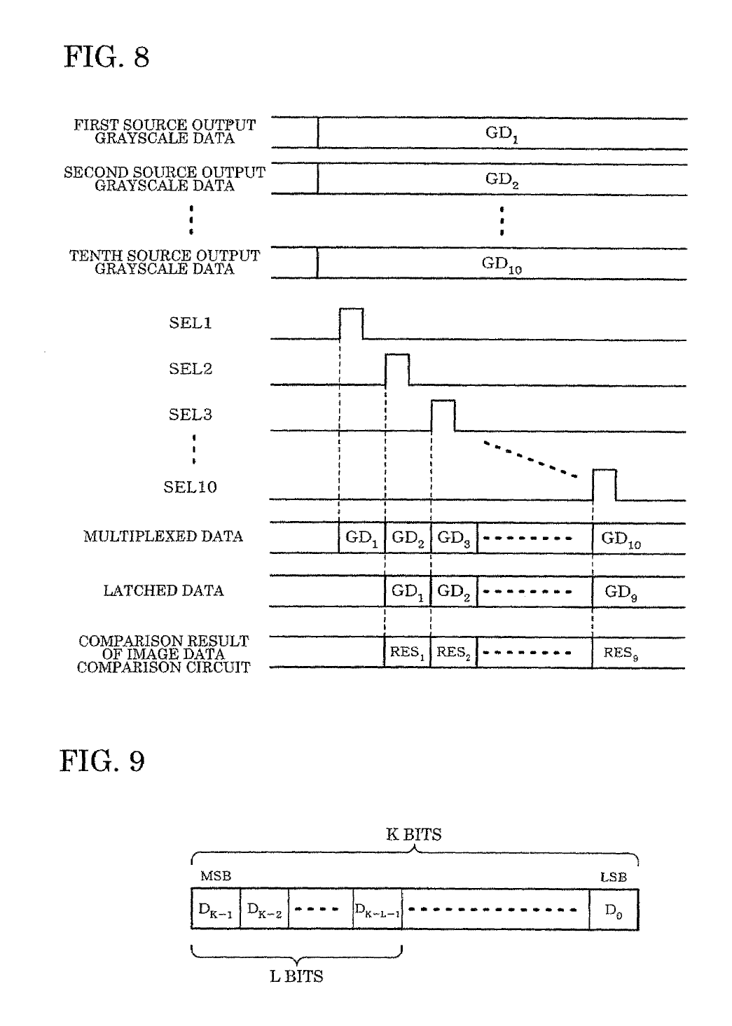

FIG. 8 shows an operation example of the multiplexer MPX₁ and the comparison circuit CMP₁ shown in FIG. 7.

The multiplexer MPX₁ generates multiplexed data by time-division multiplexing the grayscale data corresponding to ten source lines. First to tenth source output grayscale data GD₁ to GD₁₀ latched by the line latch 54 is multiplexed by the multiplexer MPX₁ of the multiplexer circuit 56. Multiplex control signals SEL1 to SEL10 that specify the time division timing are input to each of the multiplexers MPX₁ to MPXⱼ. The multiplex control signals SEL1 to SEL10 are generated by the multiplex-drive control circuit 55 of the source driver 30. The multiplex-drive control circuit 55 generates the multiplex control signals SEL1 to SEL10 so that one of the multiplex control signals SEL1 to SEL10 is sequentially set at the H level within one horizontal scan period, for example. The grayscale data corresponding to the multiplex control signal is output as the multiplexed data in a period in which the multiplex control signal is set at the H level.

The multiplexer circuit 56 may time-division multiplex the grayscale data corresponding to a plurality of pixels respectively including a plurality of dots, or may time-division multiplex the grayscale data corresponding to a plurality of dots of the same color component that form each pixel.

The grayscale data contained in the multiplexed data is latched by the latch CLT₁ every selection period specified by the multiplex control signals SEL1 to SEL10. The comparison circuit CMP1 compares the grayscale data latched by the latch CLT₁ with the grayscale data (preceding data) in the subsequent selection period contained in the multiplexed data, and outputs a comparison result RES₁. In FIG. 7, the control signals dpc1 to dpc3 and dnc1 to dnc3 are output as the comparison result RES₁.

FIG. 9 is a view illustrative of the grayscale data compared by the comparison circuit CMP₁.

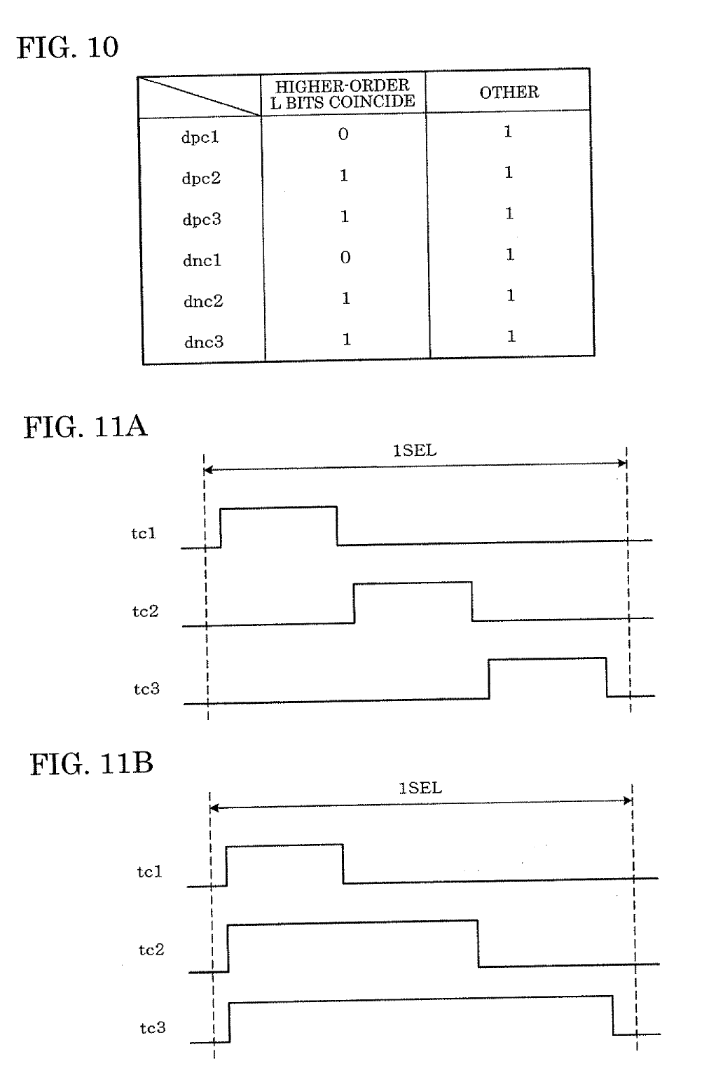

FIG. 10 is a view illustrative of the operation of the comparison circuit CMP₁.

The comparison circuit CMP₁ compares the higher-order L bits of K-bit grayscale data D_{K-1} to Do with the higher-order L bits of the K-bit grayscale data latched by the latch CLT₁.

When the comparison circuit CMP₁ has detected that the higher-order L bits of the K-bit grayscale data D_{K-1} to D₀ coincide with the higher-order L bits of the K-bit grayscale data latched by the latch CLT₁, the comparison circuit CMP₁ outputs the control signals dpc1 to dpc3 and dnc1 to dnc3 shown in FIG. 10. When the comparison circuit CMP, has detected that the higher-order L bits of the K-bit grayscale data D_{K-1} to D₀ do not coincide with the higher-order L bits of the K-bit grayscale data latched by the latch CLT₁, the comparison circuit CMP₁ sets the control signals dpc1 to dpc3 and dnc1 to dnc3 at the H level.

The control signals dpc1 to dpc3 are signals for selecting one of the three current drive capabilities of the output circuit OP₁ (signals that control p-type MOS transistors), and the control signals dnc1 to dnc3 are also signals for selecting one of the three current drive capabilities of the output circuit OP₁ (signals that control n-type MOS transistors). The control signals dpc1 to dpc3 and dnc1 to dnc3 are input to the amplifier control circuit APC₁.

Timing signals tc1 to tc3 are also input to the amplifier control circuit APC₁ from a timing control circuit (not shown) in addition to the control signals dpc1 to dpc3 and dnc1 to dnc3.

FIGS. 11A and 11B are views illustrative of examples of the timing signals te1 to tc3.

The timing signals tc1 to tc3 are signals for specifying the three current drive capabilities of the output circuit OP₁ that drives the source voltage supply line. In FIG. 11A, the timing signals tc1 to tc3 are exclusively set at the H level within one selection period. In FIG. 11B, the timing signals tc1 to tc3 are activated to sequentially overlap within one selection period.

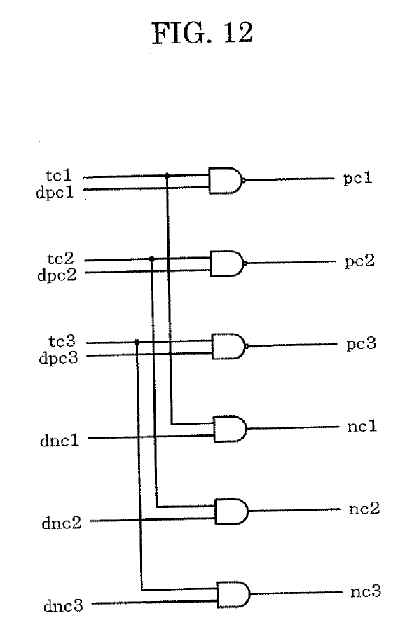

FIG. 12 is a circuit diagram shown in a configuration example of the amplifier control circuit APC₁.

The amplifier control circuit APC₁ generates the control signals pc1 to pc3 and nc1 to nc3 based on the control signals dpc1 to dpc3 and dnc1 to dnc3 and the timing signals tc1 to tc3. The control signals pc1 to pc3 are signals that control p-type MOS transistors that change the current drive capability of the output circuit OP₁, and the control signals nc1 to nc3 are signals that control n-type MOS transistors that change the current drive capability of the output circuit OP₁.

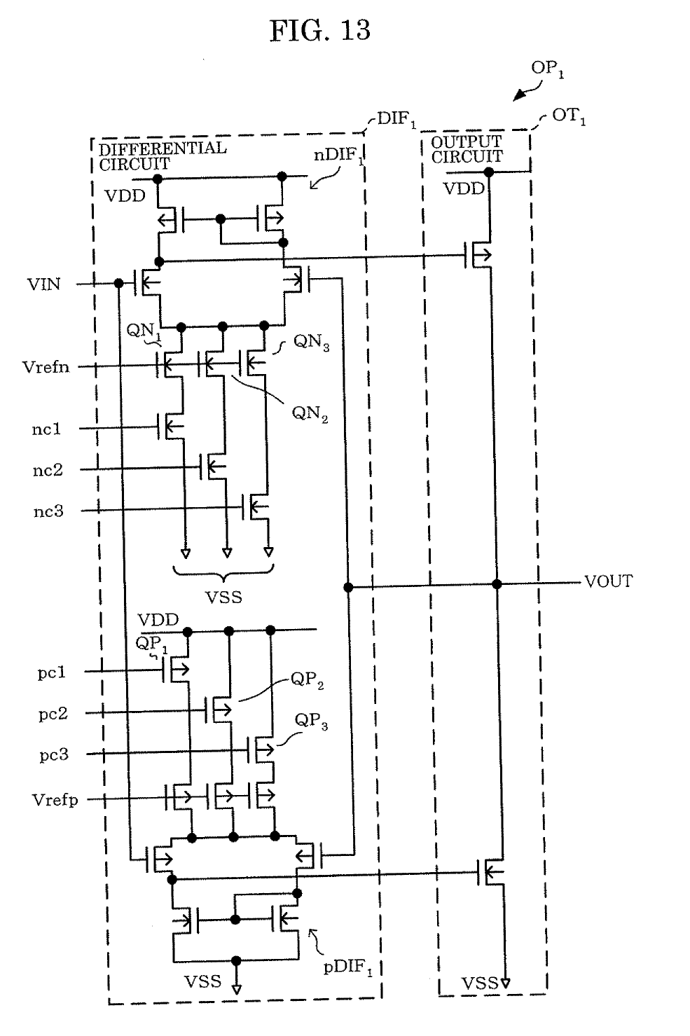

FIG. 13 is a circuit diagram showing a configuration example of the output circuit OP₁.

The output circuit OP₁ includes a differential circuit DIF₁ and an output circuit OT₁. The differential circuit DIF₁ includes an n-type differential amplifier circuit nDIF₁ and a p-type differential amplifier circuit pDIF₁.

The n-type differential amplifier circuit nDIF₁ includes a current-mirror circuit, a differential transistor pair, and a current source transistor group (QN₁, QN₂, and QN₃). The current source transistor group is connected to the sources of the differential transistor pair, and the current-mirror circuit is connected to the drains of the differential transistor pair. The current source transistor group includes three current source transistors connected in parallel. A constant voltage Vrefn is supplied to the gates of these current source transistors. n-type MOS transistors are respectively connected to the sources of the current source transistors, and the control signals nc1 to nc3 are input to the gates of the n-type MOS transistors. Therefore, the operating current of the n-type differential amplifier circuit nDIF, can be changed based on the control signals nc1 to nc3.

In FIG. 13, the operating current of the n-type differential amplifier circuit nDIF₁ can be selected from three values by causing one or more of the current source transistors QN₁ to QN₃ to be turned ON. For example, when using the timing signals shown in FIG. 11A, when the current drive capabilities of the current source transistors QN₁ to QN₃ are respectively referred to as DRN1, DRN2, and DRN3, the current source transistors QN₁ to QN₃ are formed so that DRN1>DRN2>DRN3 is satisfied. For example, when using the timing signals shown in FIG. 11B, the current source transistors QN₁ to QN₃ are formed so that DRN1=DRN2=DRN3 is satisfied.

The output voltage from the n-type differential amplifier circuit nDIF₁ is supplied to the gate of a p-type driver MOS transistor of the output circuit OT₁.

The p-type differential amplifier circuit pDIF₁ includes a current-mirror circuit, a differential transistor pair, and a current source transistor group (QP₁, QP₂, and QP₃). The current source transistor group is connected to the sources of the differential transistor pair, and the current-mirror circuit is connected to the drains of the differential transistor pair The current source transistor group includes three current source transistors connected in parallel. A constant voltage Vrefp is supplied to the gates of these current source transistors. p-type MOS transistors are respectively connected to the sources of the current source transistors, and the control signals pc1 to pc3 are input to the gates of the p-type MOS transistors. Therefore, the operating current of the p-type differential amplifier circuit pDIF₁ can be changed based on the control signals pc1 to pc3.

In FIG. 13, the operating current of the p-type differential amplifier circuit pDIF₁ can be selected from three values by causing one or more of the current source transistors QP₁ to QP₃ to be turned ON. For example, when using the timing signals shown in FIG. 1A, when the current drive capabilities of the current source transistors QP₁ to QP₃ are respectively referred to as DRP1, DRP2, and DRP3, the current source transistors QP₁ to QP₃ are formed so that DRP1>DRP2>DRP3 is satisfied. For example, when using the timing signals shown in FIG. 11B, the current source transistors QP₁ to QP₃ are formed so that DRP1=DRP2=DRP3 is satisfied.

The output voltage from the p-type differential amplifier circuit nDIF₁ is supplied to the gate of an n-type driver MOS transistor of the output circuit OT₁.

The output circuit OT₁ outputs the voltage of an output node connected to the drain of the p-type driver MOS transistor and the drain of the n-type driver MOS transistor as an output voltage. The output node is connected to the gate of the transistor of the differential transistor pair of the n-type differential amplifier circuit nDIF₁ to which to an input voltage VIN is not input. The output node is connected to the gate of the transistor of the differential transistor pair of the p-type differential amplifier circuit pDIF₁ to which to the input voltage VIN is not input.

The source voltage supply line to which an output voltage VOUT from the output circuit OP₁ having such a configuration is supplied is connected to the is demultiplexer of the LCD panel 20.

In the above-described example, the current drive capabilities of the n-type differential amplifier circuit nDIF₁ and the p-type differential amplifier circuit pDIF₁ are simultaneously increased or decreased. Note that the invention is not limited thereto. The current drive capability of one of the n-type differential amplifier circuit nDIF₁ and the p-type differential amplifier circuit pDIF₁ may be increased or decreased

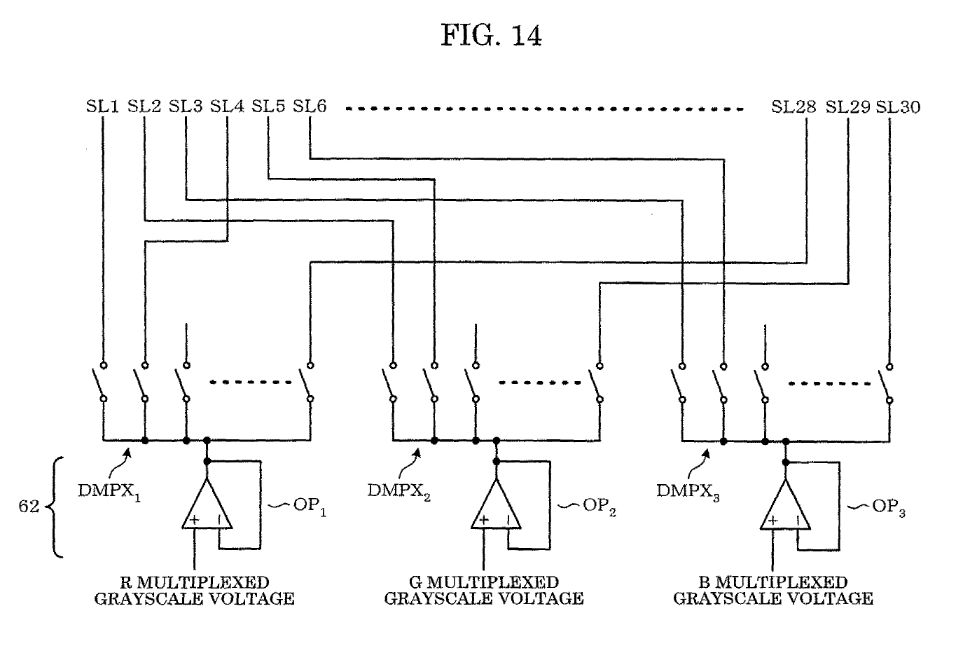

FIG. 14 is a circuit diagram showing a configuration example of the demultiplexer of the LCD panel 20.

In FIG. 14, the output circuits provided corresponding to RGB color components perform 10-multiplex drive. In this case, each demultiplexer performs an operation which is the reverse of that of the multiplexer of the multiplexer circuit 56 corresponding to the demultiplexer. Specifically, each demultiplexer separates the multiplexed grayscale voltage from each output circuit of the source line driver circuit 62, and outputs the separated grayscale voltages to ten source outputs. The separation timing of the demultiplexer is synchronized with the time division timing of each multiplexer of the multiplexer circuit 56.

FIG. 14 shows an example of the demultiplexers DMPX₁ to DMPX₃ that separate the multiplexed grayscale voltage corresponding to the source lines SL1 to SL30. Each demultiplexer separates the grayscale voltage corresponding to each color component of one pixel. Specifically, each output circuit OP₁ of the source driver 30 drives the source voltage supply line so that 10-multiplex drive is performed corresponding to each color component. This prevents a phenomenon in which a separation line occurs due to a variation in the output circuit OP1 even when the same grayscale voltage is output, whereby the image quality can be improved.

An R multiplexed grayscale voltage (for the R component among the RGB components) is input to the output circuit OP₁ from the voltage select circuit DEC₁ of the DAC 60. The output circuit OP₁ performs impedance conversion using the R multiplexed grayscale voltage, and drives its output. Demultiplex control signals synchronized with the time division timing of the multiplexer circuit 56 are input to the demultiplexer DMPX₁. The demultiplexer DMPX₁ sequentially outputs the output voltage from the output circuit OP₁ to the source lines SL1, SL4, SL7, SL10, . . . , and SL28 only in a period specified by demultiplex control signals.

A G multiplexed grayscale voltage (for the C component among the ROB components) is input to the output circuit OP₂ from the voltage select circuit DEC₂ of the DAC 60. The output circuit OP₂ performs impedance conversion using the G multiplexed grayscale voltage, and drives its output. The demultiplex control signals synchronized with the time division timing of the multiplexer circuit 56 are input to the demultiplexer DMPX₂. The demultiplexer DMPX₂ sequentially outputs the output voltage from the output circuit OP₂ to the source lines SL2, SL5, SL8, SL11, . . . , and SL29 only in a period specified by demultiplex control signals.

A B multiplexed grayscale voltage (for the B component among the RGB components) is input to the output circuit OP₃ from the voltage select circuit DEC₃ of the DAC 60. The output circuit OP₃ performs impedance conversion using the B multiplexed grayscale voltage, and drives its output. The demultiplex control signals synchronized with the time division timing of the multiplexer circuit 56 are input to the demultiplexer DMPX₃. The demultiplexer DMPX₃ sequentially outputs the output voltage from the output circuit OP₃ to the source lines SL3, SL6, SL9, SL12, . . . , and SL30 only in a period specified by demultiplex control signals.

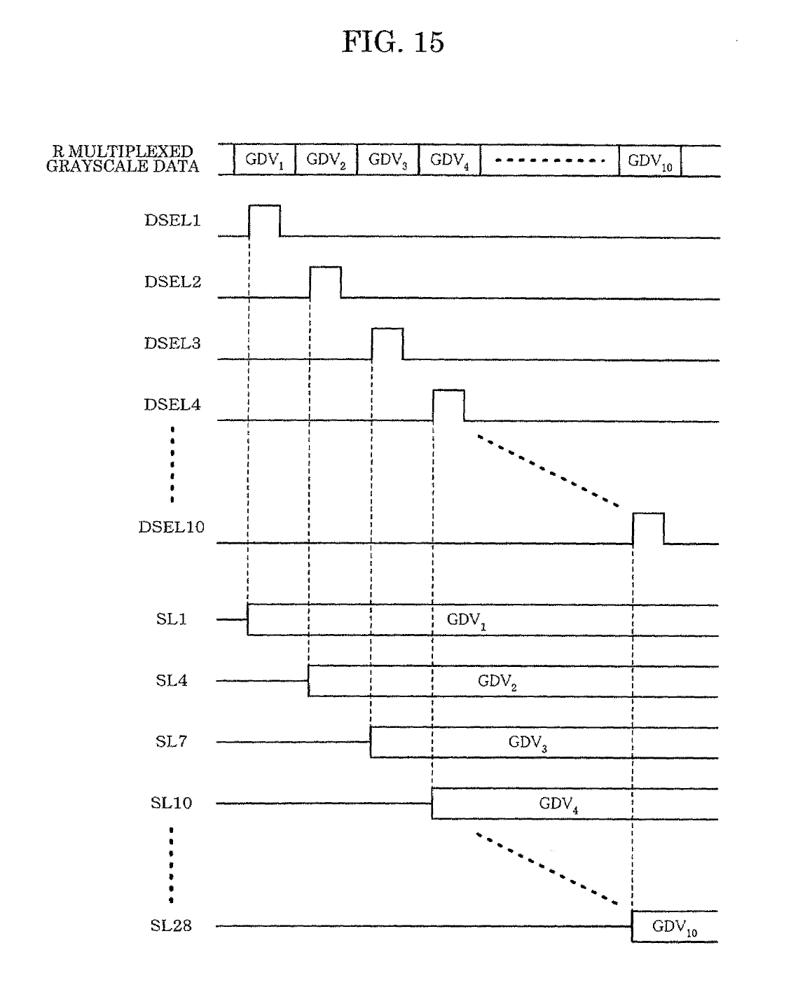

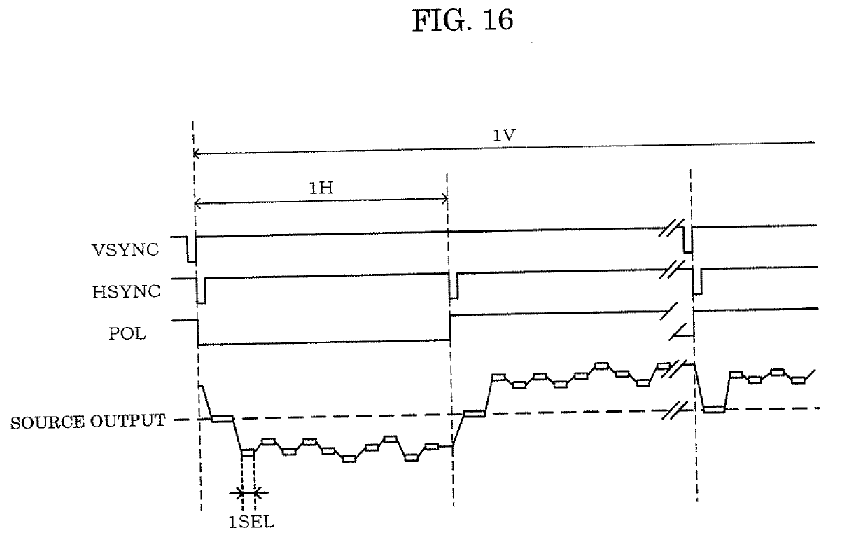

FIG. 15 is a view illustrative of the operation of the demultiplexer shown in FIG. 14.

FIG. 15 illustrates the operation of the demultiplexer DMPX₁ shown in FIG. 14. Note that other demultiplexers operate in the same manner as the demultiplexer DMPX₁.

The demultiplexer DMUX₁ separates the grayscale voltages GDV₁, GDV₂, GDV₃, . . . , and GDV₁₀ time-division multiplexed as the R multiplexed grayscale voltage, and outputs the separated grayscale voltages to the source lines. The grayscale voltage GDV₁ is the grayscale voltage corresponding to the grayscale data GD₁ among a plurality of grayscale voltages generated by the grayscale voltage generation circuit 58. The grayscale voltage GDV₂ is the grayscale voltage corresponding to the grayscale data GD₂, among a plurality of grayscale voltages generated by the grayscale voltage generation circuit 58. Likewise, the grayscale voltage GDV₁₀ is the grayscale voltage corresponding to the grayscale data GD₁₀ among a plurality of grayscale voltages generated by the grayscale voltage generation circuit 58.

Demultiplex control signals DSEL1 to SEL10 are input to the demultiplexers DMPX₁ to DMPX₃. The demultiplex control signals DSEL1 to DSEL10 are signals synchronized with the multiplex control signals SEL1 to SEL10, respectively. The demultiplex control signals DSEL1 to DSEL10 are generated by the multiplex-drive control circuit 55 of the source driver 30. The multiplex-drive control circuit 55 generates the demultiplex control signals DSEL1 to DSEL10 so that one of the demultiplex control signals DSEL1 to DSEL10 is sequentially set at the H level within one horizontal scan period, for example. The grayscale voltage in a period in which the demultiplex control signal is set at the H level among the grayscale voltages multiplexed into the R multiplexed grayscale data is output to the source line corresponding to the demultiplex control signal.

Therefore, the demultiplexer DMPX₁ can output the grayscale voltages GDV₁, GDV₂, GDV₃, . . . , and GDV₁₀ separated from the R multiplexed grayscale voltage (see FIG. 15) to the source lines SL1, SL4, SL7, . . . , and SL28. The demultiplexers DMPX₂ and DMPX₃ can also output the grayscale voltages separated from the G multiplexed grayscale voltage and the B multiplexed grayscale voltage to the source lines in the same manner as the demultiplexer DMPX₁.

FIG. 16 is a timing diagram showing an operation example of the source driver 30 according to this embodiment.

In FIG. 16, a plurality of horizontal scan periods are provided within one vertical scan period (1 V) that starts at the change timing of the vertical synchronization signal VSYNC. The horizontal scan period is specified by the change timing of the horizontal synchronization signal HSYNC. The polarity inversion signal POL is a signal that specifies the polarity of the voltage applied to the liquid crystal. The polarity inversion signal POL is alternately set at the H level and the L level every horizontal scan period.

The source driver 30 outputs a precharge voltage to the source output using a precharge circuit (not shown) when the horizontal scan period has started, and then performs 10-multiplex drive. In FIG. 16, 10-multiplex drive is started after precharging in each horizontal scan period, and the source output voltage changes every selection period (1SEL).

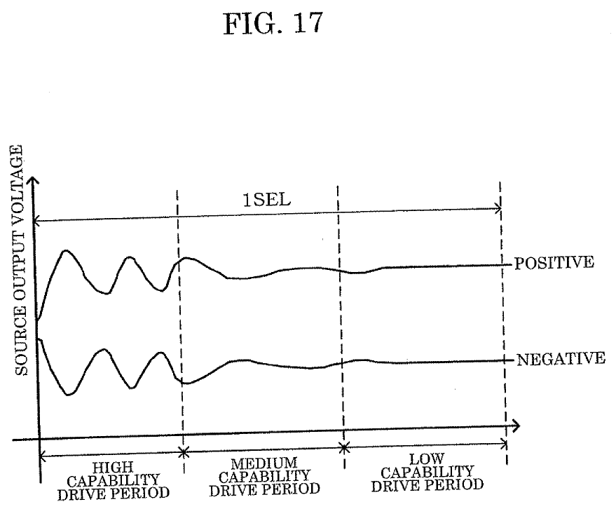

FIG. 17 shows an example of the source output of the source driver 30 within one selection period shown in FIG. 16.

FIG. 17 shows a positive waveform and a negative waveform during polarity inversion drive. In the source driver 30 according to this embodiment, a high capability drive period and a medium capability drive period occur in that order within one selection period (1SEL). A low capability drive period then occurs within one selection period.

Specifically, when the higher-order L bits of the grayscale data in the current period do not coincide with the higher-order L bits of the preceding data, the source driver 30 (output circuit OP₁ or amplifier circuit) drives the source line with the first current drive capability based on the grayscale data (high capability drive period), then drives the source line with the third current drive capability based on the grayscale data (medium capability drive period), and then drives the source line with the second current drive capability based on the grayscale data (low capability drive period) within one selection period. In the high capability drive period, the medium capability drive period, and the low capability drive period, the source driver 30 subjects the grayscale voltage corresponding to the same grayscale data impedance conversion, and outputs the resulting grayscale voltage to the source line. The first current drive capability, the second current drive capability, and the third current drive capability satisfy the relationship “first current drive capability>second current drive capability>third current drive capability”. The current drive capability is gradually reduced within one selection period. For example, the slew rate of the output circuit OP₁ may be set at 100 V/μS (e.g., the load capacitance is 5 pF) when driving the source line with the first current drive capability, may be set at 50 V/μS (e.g., the load capacitance is 5 pF) when driving the source line with the third current drive capability, and may be set at 20 V/μS (e.g., the load capacitance is 5 pF) when driving the source line with the second current drive capability.

The high capability drive period is a period that causes the potential of the source line to be quickly set at the target potential (target point), the medium capability drive period is a period that causes the potential of the source line to converge at the target potential, and the low capability drive period is a period that causes the potential of the source line to be accurately set at the target potential.

In this embodiment, even when a change in potential between the selection periods shown in FIG. 16 is small, the high capability drive period is omitted when the higher-order L bits of the grayscale data in the current period do not coincide with the higher-order L bits of the preceding data in order to suppress ringing. Specifically, the source line is driven with the second or third current drive capability without driving the source line with the first current drive capability. Note that the medium capability drive period may be omitted when the output circuit OP₁ drives the source line with two current drive capabilities. In this case, the high capability drive period may be omitted when the higher-order L bits of the grayscale data in the current period do not coincide with the higher-order L bits of the preceding data, and the source line may be driven with the second current drive capability without driving the source line with the first current drive capability

When driving the source line while switching between a plurality of current drive capabilities, current consumption can be reduced to a large extent by changing the current drive capability based on the comparison result between the grayscale data in the current drive period and the preceding data corresponding to the preceding drive level, as described in this embodiment.

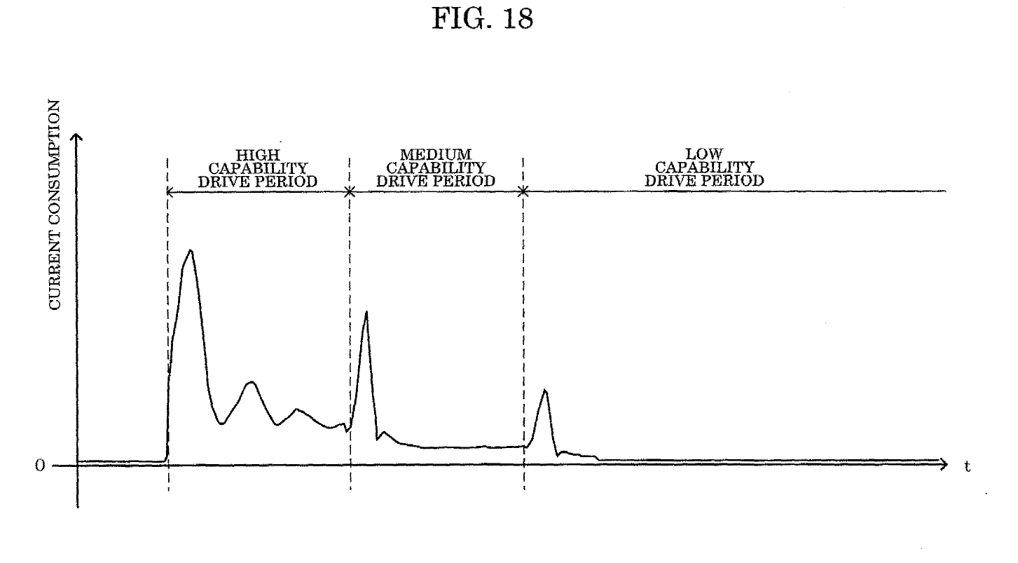

FIG. 18 shows an example of a change in current consumption of the output circuit OP₁ shown in FIG. 13 with the passage of time.

In FIG. 18, the vertical axis indicates current consumption, and the horizontal axis indicates time. FIG. 18 shows a change in current consumption corresponding to one output within one selection period.

The current consumption temporarily increases at the start (change) timing of the high capability drive period, the change timing from the high capability drive period to the medium capability drive period, and the change timing from the medium capability drive period to the low capability drive period. The following discussion focuses on the direct current in each drive period. The direct current in the high capability drive period is smaller than the direct current in the medium capability drive period. The direct current in the medium capability drive period is smaller than the direct current in the low capability drive period. The direct current in the low capability drive period is approximately zero.

Therefore, if the high capability drive period is omitted when the higher-order L bits of the grayscale data in the current period do not coincide with the higher-order L bits of the preceding data, as described in this embodiment, ringing can be suppressed while reducing current consumption in an amount corresponding to the direct current in the high capability drive period. According to this embodiment, ringing can be suppressed while reducing current consumption. Moreover, since each source output of the source driver 30 is independently controlled instead of uniformly controlling all of the source outputs, unnecessary current consumption can be reduced.

3.3 Modification

3.3.1 First Modification

In the above-described configuration example, the current drive capability is changed based on the comparison result between the image data and the preceding data. On the other hand, a period in which the source line is driven with each current drive capability is determined in advance. In a first modification, even when the source line is driven with the same current drive capability, a period in which the source line is driven with each current drive capability is changed based on the comparison result between the image data and the preceding data. This makes it possible to finely control the potential of the source line without increasing the number of current drive capabilities of the amplifier circuit.

The configuration of the source driver according to the first modification is similar to that shown in FIG. 6. Therefore, illustration and description thereof are omitted.

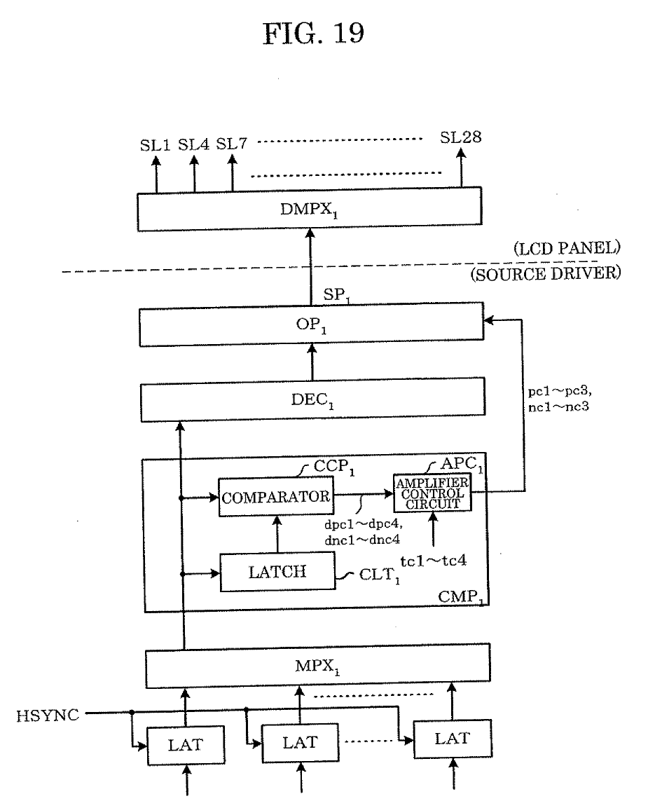

FIG. 19 is a block diagram showing a configuration example of the source driver according to the first modification corresponding to one source output.

In FIG. 19, the same sections as in FIG. 7 are indicated by the same symbols. Description of these sections is appropriately omitted. The comparator CCP₁ shown in FIG. 19 differs from the comparator CCP₁ shown in FIG. 7 in that the comparator CCP₁ shown in FIG. 19 can detect whether or not the higher-order p bits (L<p<K, p is a natural number) of the grayscale data time-division multiplexed by the multiplexer MPX₁ coincide with the higher-order p bits of the grayscale data latched by the latch CLT₁ every selection period specified by the multiplex control signal, instead of, or in addition to, the function of the comparator CCP₁ shown in FIG. 7. The comparator CCP₁ outputs the control signals dpc1 to dpc4 and dnc1 to dnc4 based on the comparison result. The timing signals tc1 to tc4 are input to the amplifier control circuit APC₁. The output circuit OP₁ (amplifier circuit) drives the source line with the first current drive capability for a reduced period of time, and then drives the source line with the second current drive capability.

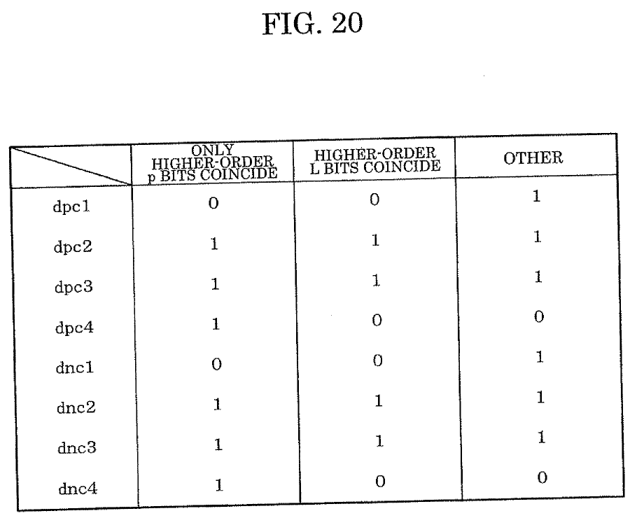

FIG. 20 is a view illustrative of the operation of the comparison circuit CMP₁ according to the first modification.

The comparison circuit CMP₁ according to the first modification compares the higher-order p bits of the K-bit grayscale data D_{K-1} to D₀ with the higher-order p bits of the K-bit grayscale data latched by the latch CLT₁, and compares the higher-order L bits of the K-bit grayscale data D_{K-1} to D₀ with the higher-order L bits f the K-bit grayscale data latched by the latch CLT₁.

When the comparison circuit CMP₁ has detected that the higher-order p its of the K-bit grayscale data D_{K-1} to D₀ coincide with the higher-order p bits of the K-bit grayscale data latched by the latch CLT₁, the comparison circuit CMP₁ outputs the control signals dpc1 to dpc4 and dnc1 to dnc4 (the control signals dpc4 and dnc4 are set at the H level) shown in FIG. 20, for example. When the comparison circuit CMP₁ has detected that the higher-order p bits of the K-bit grayscale data D_{K-1} to D₀ do not coincide with the higher-order p bits of the K-bit grayscale data latched by the latch CLT₁, but the higher-order L bits of the K-bit grayscale data D_{K-1} to D₀ coincide with the higher-order L bits of the K-bit grayscale data latched by the latch CLT₁, the comparison circuit CMP₁ outputs the control signals dpc1 to dpc4 and dnc1 to dnc4 (the control signals dpc4 and dnc4 are set at the L level) shown in FIG. 20. When the comparison circuit CMP₁ has detected that the higher-order p bits of the K-bit grayscale data D_{K-1} to D₀ do not coincide with the higher-order p bits of the K-bit grayscale data latched by the latch CLT₁ and the higher-order L bits of the K-bit grayscale data D_{K-1} to D₀ do not coincide with the higher-order L bits of the K-bit grayscale data latched by the latch CLT₁, the comparison circuit CMP₁ sets the control signals dpc1 to dpc3 and dnc1 to dnc3 excluding the control signals dpc4 and dnc4 at the H level. The control signals dpc1 and dpc4 are not simultaneously set at the H level, and the control signals dnc1 and dnc4 are not simultaneously set at the H level.

The control signals dpc1 to dpc4 are signals for selecting one of the three current drive capabilities of the output circuit OP₁ (signals that control p-type MOS transistors), and the control signals dnc1 to dnc4 are also signals for selecting one of the three current drive capabilities of the output circuit OP₁ (signals that control n-type MOS transistors). The control signals dpc1 to dpc4 and dnc1 to dnc4 are input to the amplifier control circuit APC₁.

The timing signals tc1 to tc4 are also input to the amplifier control circuit APC₁ from a timing control circuit (not shown) in addition to the control signals dpc1 to dpc4 and dnc1 to dnc4,

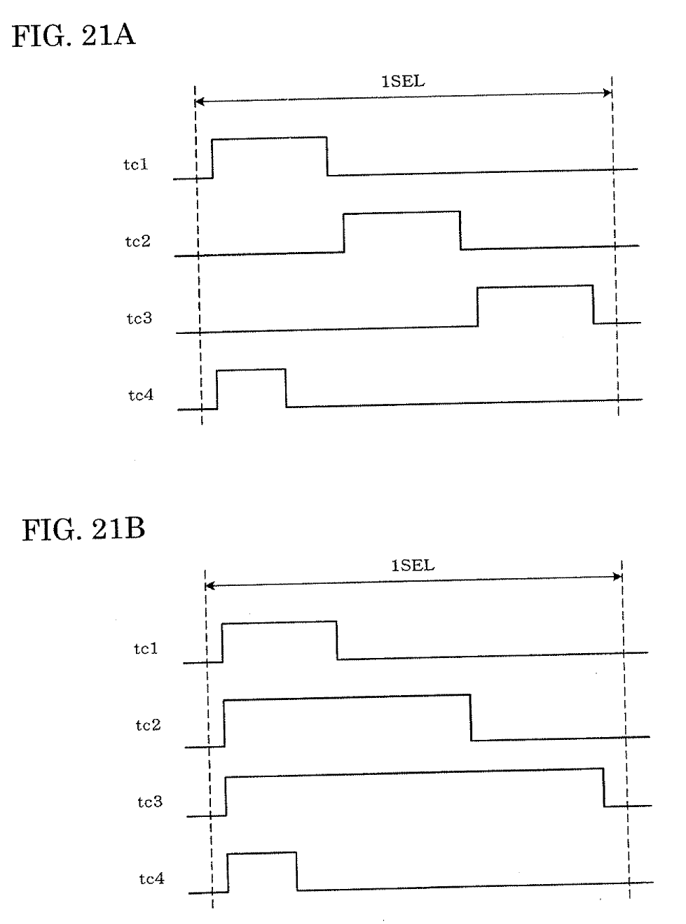

FIGS. 21A and 21B are views illustrative of examples of the timing signals tc1 to tc4.

The timing signals tc1 to tc4 are signals for specifying the three current drive capabilities of the output circuit OP₁ that drives the source voltage supply line, or specifying a period in which the output circuit OP₁ drives the source voltage supply line with a single current drive capability. In FIG. 21A, the timing signals tc1 to tc3 are exclusively set at the H level within one selection period, and the timing signal tc4 is set at the H level for a period shorter than that of the timing signal tc1. In FIG. 21B, the timing signals tc1 to tc3 are activated to sequentially overlap within one selection period, and the timing signal tc4 is set at the H level for a period shorter than that of the timing signal tc1.

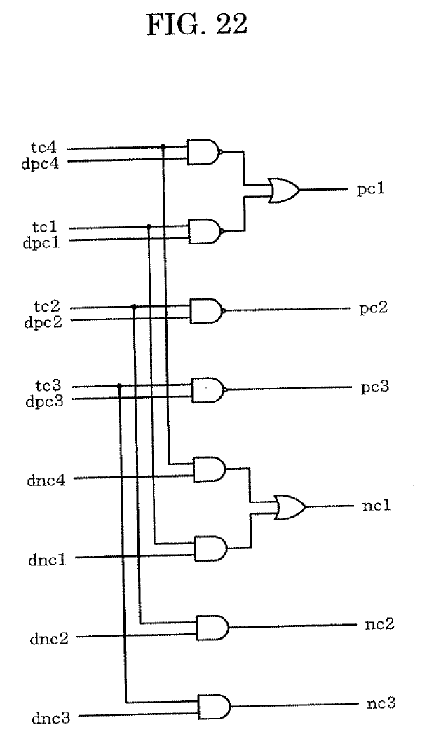

FIG. 22 is a circuit diagram showing a configuration example of the amplifier control circuit APC₁ according to the first modification.

The amplifier control circuit APC₁ according to the first modification generates the control signals pc1 to pc3 and nc1 to nc3 based on the control signals dpc1 to dpc4 and dnc1 to dnc4 and the timing signals tc1 to tc4. The control signals pc1 to pc3 are signals that control p-type MOS transistors that change the current drive capability of the output circuit OP₁, and the control signals nc1 to nc3 are signals that control n-type MOS transistors that change the current drive capability of the output circuit OP₁.

As shown in FIG. 22, when the control signal dpc4 is set at the H level, the control signal pc1 is activated for a period designated by the timing signal tc4. Therefore, a period in which the source line is driven with the first current drive capability is reduced as compared with the case where the control signal dpc1 is set at the H level. As shown in FIG. 22, when the control signal dnc4 is set at the H level, the control signal nc1 is activated for a period designated by the timing signal tc4. Therefore, a period in which the source line is driven with the first current drive capability is reduced as compared with the case where the control signal dnc1 is set at the H level.

In the first modification, the current drive capability is switched between the three current drive capabilities. Note that the number of current drive capabilities may be two or four or more. In the first modification, a period in which the source line is driven with the first current drive capability is changed. Note that a period in which the source line is driven with the second or third current drive capability may be changed.

According to the first modification with the above-described configuration, when the higher-order p bits of the grayscale data merely coincide with the higher-order p bits of the preceding data, the amplifier circuit can drive the source line with the first current drive capability for a reduced period of time, and then drive the source line with the second current drive capability.

3.3.2 Second Modification

In this embodiment or the first modification, the grayscale data in the selection period immediately before the current selection period or the grayscale data in the drive period immediately before the current drive period is used as the preceding data. Note that the preceding data is not limited thereto. In a second modification, the average value of the multiplexed data when performing multiplex drive may be used as the preceding data. This makes it unnecessary to compare the grayscale data every selection period, whereby power consumption can be reduced.

The configuration of the source driver according to the second modification is similar to that shown in FIG. 6. Therefore, illustration and description thereof are omitted.

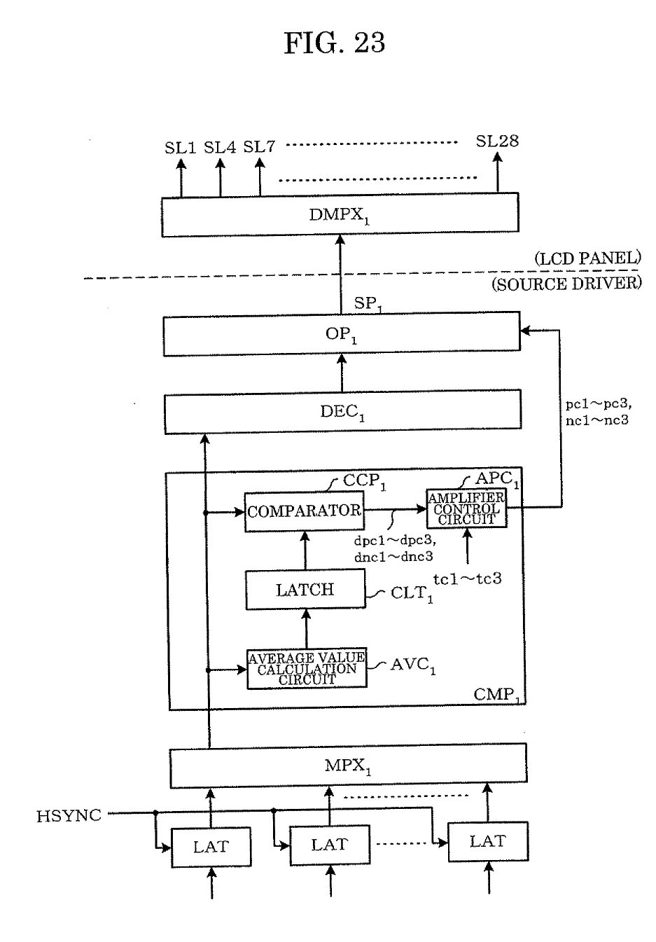

FIG. 23 is a block diagram showing a configuration example of the source driver according to the second modification corresponding to one source output.

In FIG. 23, the same sections as in FIG. 7 are indicated by the same symbols. Description of these sections is appropriately omitted. The comparator CCP₁ shown in FIG. 23 differs from the comparator CCP₁ shown in FIG. 7 in that the comparator CCP₁ shown in FIG. 23 includes an average value calculation circuit AVC₁ .

The average value calculation circuit AVC₁ sums up the grayscale data of the time-division multiplexed data, and calculates the average value of the grayscale data. For example, when performing 10-multiplex drive, multiplexed data is obtained by multiplexing the grayscale data GD₁, GD₂, and GD₃, . . . , and GD₁₀, as shown in FIG. 8. The average value calculation circuit AVC₁ calculates the average value of the grayscale data by dividing the sum of the grayscale data by the multiplex count (i.e., the number of pieces of multiplexed data). In this case, the average value calculation circuit AVC₁ calculates the average value of the grayscale data by calculating (GD₁+GD₂+GD₃+ . . . +GD₁₀)/10. The average value is latched by the latch CLT₁. The comparator CCP₁ detects whether or not the higher-order L bits of the grayscale data time-division multiplexed by the multiplexer MPX₁ coincide with the higher-order L bits of the grayscale data latched by the latch CLT₁ every selection period specified by the multiplex control signal.

In the second modification, the comparator CCP₁ merely compares the higher-order L bits of the grayscale data time-division multiplexed by the multiplexer MPX₁ with the higher-order L bits of the grayscale data latched by the latch CLT₁. Note that the comparator CCP₁ may compare the higher-order p bits of the grayscale data time-division multiplexed by the multiplexer MPX₁ with the higher-order p bits of the grayscale data latched by the latch CLT₁, and compare the higher-order L bits of the grayscale data time-division multiplexed by the multiplexer MPX₁ with the higher-order L bits of the grayscale data latched by the latch CLT₁ so that a period in which the source line is driven with a single current drive capability may be changed in addition to changing the current drive capability.

Specifically, when performing multiplex drive that drives a plurality of source lines based on the time-division multiplexed grayscale data using an amplifier circuit that drives the source line with the first current drive capability and then drives the source line with the second current drive capability, the image data comparison circuit may compare the average value of the time-division multiplexed image data with the preceding data, and the amplifier circuit may drive the source line with the second current drive capability without driving the source line with the first current drive capability when the image data comparison circuit has detected that the higher-order L 10 bits of the average value coincide with the higher-order L bits of the preceding data. When the image data comparison circuit has detected that the higher-order p bits of the average value merely coincide with the higher-order p bits of the preceding data, the amplifier circuit may drive the source line with the first current drive capability for a reduced period of time, and then drive the source line with the second current drive capability.

3.3.3 Third Modification

In the above-described configuration example or the first or second modification, the grayscale data corresponding to the preceding drive voltage is used as the preceding data. Note that the preceding data is not limited thereto. For example, a precharge operation may be performed when the drive period starts.

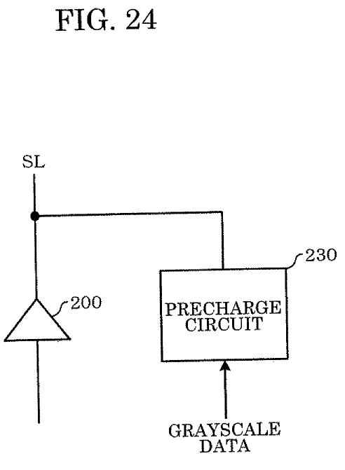

FIG. 24 shows the main portion of the configuration of the source output according to a third modification.

Specifically, the output of a precharge circuit 230 is connected to the output of the amplifier circuit 200. The precharge circuit 230 outputs a precharge voltage when the drive period starts. The precharge voltage set during precharging may be a constant (fixed) voltage or a voltage associated with one piece of grayscale data. A constant voltage can be associated with the grayscale data. Therefore, the precharge voltage can also be associated with the grayscale data regardless of whether or not the precharge voltage is a constant voltage. Therefore, the preceding data may be data corresponding to the precharge potential of the source line. In this case, the preceding data is data corresponding to the preceding drive level.

3.3.4 Fourth Modification

In the above-described configuration example and the first to third modifications, the source driver multiplex-drives the LCD panel 20 (high-temperature polysilicon liquid crystal panel) on which the demultiplexers DMPX₁ to DMPXⱼ are formed. Note that the source driver is not limited thereto.

A source driver according to a fourth modification drives an LCD panel (amorphous silicon liquid crystal panel) in which the demultiplexers DMPX₁ to DMPXⱼ are not formed on a panel substrate. In this case, the source driver has the function of the demultiplexers DMPX₁ to DMPXⱼ in the above-described configuration example and the first to third modifications.

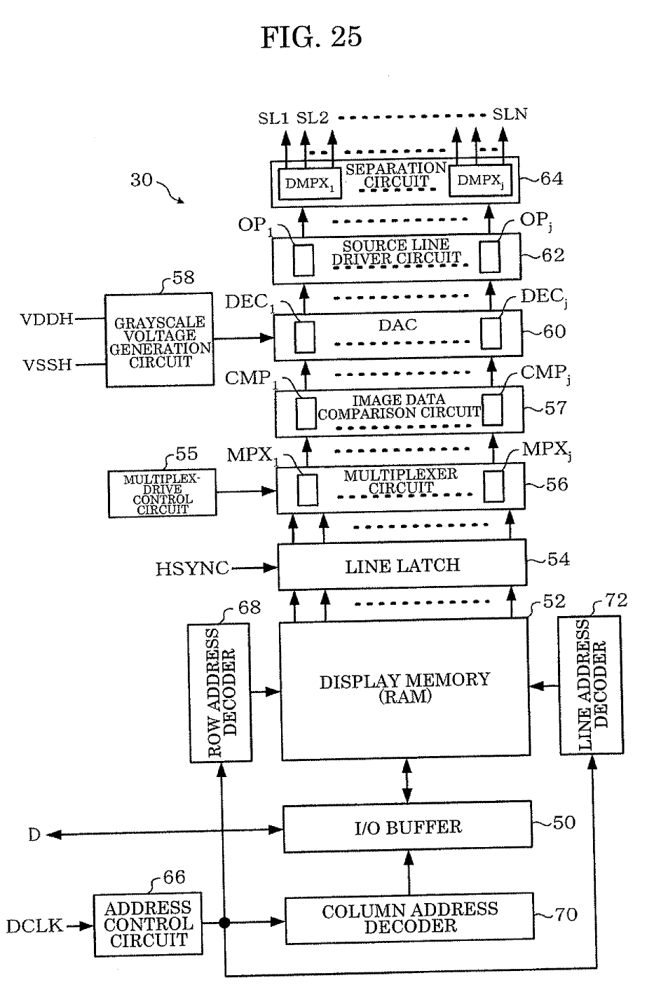

FIG. 25 is a block diagram showing the source driver according to the fourth modification.

In FIG. 25, the same sections as in FIG. 6 are indicated by the same symbols. Description of these sections is appropriately omitted. The source driver shown in FIG. 25 differs from the source driver shown in FIG. 6 in that a separation circuit 64 is provided on the output side of the source line driver circuit 62. The separation circuit 64 includes the demultiplexers DMPX₁ to DMPXⱼ provided on the LCD panel 20 in FIG. 1 or 2. The function of the separation circuit 64 is the same as described with reference to FIG. 15. Therefore, detailed description is omitted.

4. Electronic Instrument

An electronic instrument to which the liquid crystal device 10 (source driver 30) according to the above embodiment is applied is described below.

4.1 Projection-Type Display Device

An electronic instrument formed using the liquid crystal device 10 may be a projection-type display device.

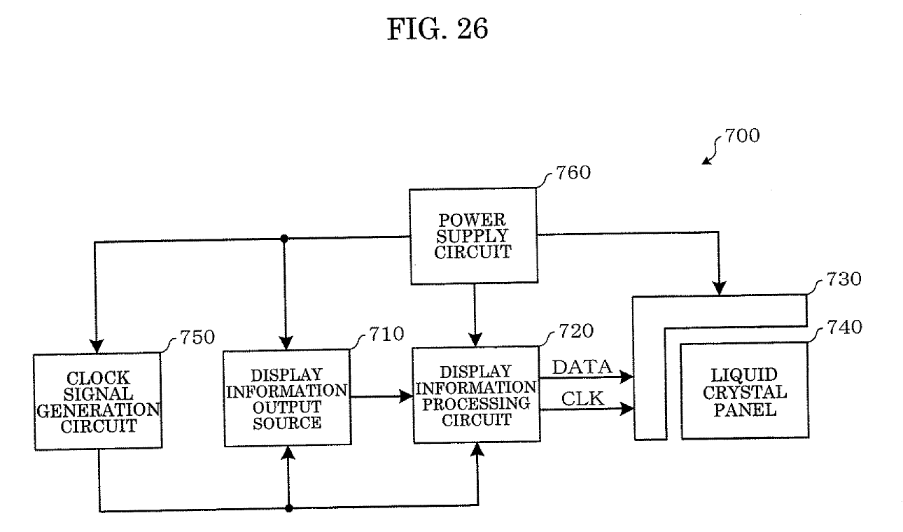

FIG. 26 is a block diagram showing a configuration example of a projection-type display device to which the liquid crystal device 10 according to the above embodiment is applied.

A projection-type display device 700 includes a display information output source 710, a display information processing circuit 720, a display driver circuit 730 (display driver), a liquid crystal panel 740, a clock signal generation circuit 750, and a power supply circuit 760. The display information output source 710 includes a memory such as a read only memory (ROM), a random access memory (RAM), or an optical disk device, and a tuning circuit which tunes and outputs an image signal. The display information output source 710 outputs display information (e.g., image signal in a given format) to the display information processing circuit 720 based on a clock signal from the clock signal generation circuit 750. The display information processing circuit 720 may include an amplification/polarity inversion circuit, a phase expansion circuit, a rotation circuit, a gamma correction circuit, a clamping circuit, and the like. The display driver circuit 730 includes a gate driver and a source driver. The display driver circuit 730 drives the liquid crystal panel 740. The power supply circuit 760 supplies power to each circuit.

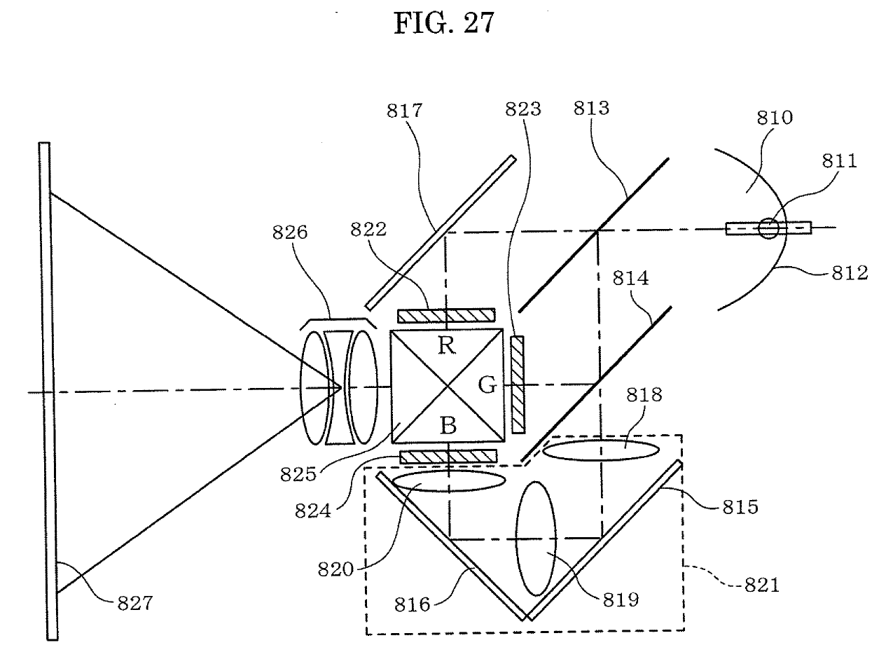

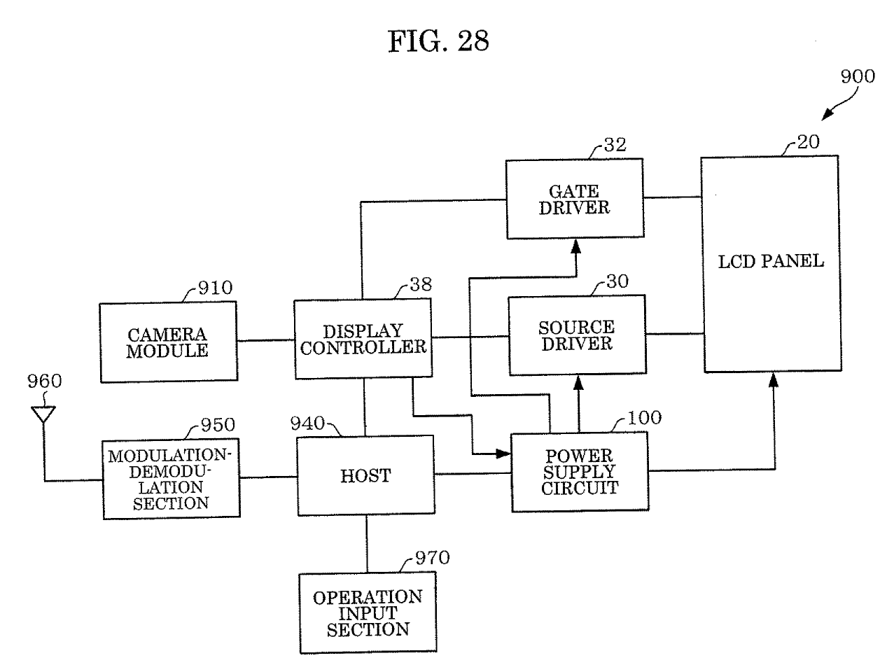

FIG. 27 is a schematic view showing the main portion of the projection-type display device.

The projection-type display device includes a light source 810, dichroic mirrors 813 and 814, reflection mirrors 815, 816, and 817, an incident lens 818, a relay lens 819, an exit lens 820, liquid crystal light modulators 822, 823, and 824, a cross dichroic prism 825, and a projection lens 826. The light source 810 includes a lamp 811 (e.g., metal halide lamp), and a reflector 812 that reflects light emitted from the lamp. The dichroic mirror 813 that reflects blue/green light allows red light contained in a beam from the light source 810 to pass through, and reflects blue light and green light. Red light that has passed through the dichroic mirror 813 is reflected by the reflection mirror 817, and enters the red light liquid crystal light modulator 822. Green light reflected by the dichroic mirror 813 is reflected by the dichroic mirror 814 that reflects green light, and enters the green light liquid crystal light modulator 823. Blue light also passes through the second dichroic mirror 814. A photo-conductive means 821 formed of a relay lens system including the incident lens 818, the relay lens 819, and the exit lens 820 is provided for blue light in order to prevent optical loss due to a long optical path. Blue light enters the blue light liquid crystal light modulator 824 through the photo-conductive means 821 The three color light rays modulated by each light modulator circuit enter the cross dichroic prism 825. Four rectangular prisms are bonded in the cross dichroic prism 825, and a dielectric multilayer film that reflects red light and a dielectric multilayer film that reflects blue light are formed on the inner side in the shape of a cross. The three color light rays are synthesized by the dielectric multilayer films so that light that represents a color image is formed. The projection means of the projection-type display device is formed as described above. Light synthesized by the projection means is projected onto a screen 827 by a projection lens 826 (projection optical system) so that an enlarged image is displayed.

4.2 Portable Telephone

An electronic instrument formed using the liquid crystal device 10 may be a portable telephone.

FIG. 28 is a block diagram showing a configuration example of a portable telephone to which the liquid crystal device 10 according to the above embodiment is applied. In FIG. 28, the same sections as in FIG. 1 or 2 are indicated by the same symbols. Description of these sections is appropriately omitted.

A portable telephone 900 includes a camera module 910. The camera module 910 includes a CCD camera, and supplies data relating to an image captured using the CCD camera to a display controller 38 in a YUV format.

The portable telephone 900 includes an LCD panel 20. The LCD panel 20 is driven by a source driver 30 and a gate driver 32. The LCD panel 20 includes a plurality of gate lines, a plurality of source lines, and a plurality of pixels.

The display controller 38 is connected to the source driver 30 and the gate driver 32, and supplies grayscale data in an ROB format to the source driver 30.

A power supply circuit 100 is connected to the source driver 30 and the gate driver 32, and supplies drive power supply voltages to the source driver 30 and the gate driver 32. The power supply circuit 100 supplies the common electrode voltage Vcom to the common electrode of the LCD panel 20.

A host 940 is connected to the display controller 38. The host 940 controls the display controller 38. The host 940 demodulates grayscale data received through an antenna 960 using a modulation-demodulation section 950, and supplies the demodulated grayscale data to the display controller 38. The display controller 38 causes the source driver 30 and the gate driver 32 to display an image on the LCD panel 20 based on the grayscale data.

The host 940 modulates grayscale data generated by the camera module 910 using the modulation-demodulation section 950, and instructs transmission of the modulated data to another communication device via the antenna 960.

The host 940 transmits and receives grayscale data, captures an image using the camera module 910, and displays an image on the LCD panel 20 based on operation information from an operation input section 970.

In FIG. 28, the host 940 or the display controller 38 may be referred to as a means that supplies the grayscale data.

Examples of an electronic instrument to which this embodiment or its modification may be applied include a personal computer, a personal computer peripheral instrument (e.g., printer, scanner, or complex machine), a portable telephone, a portable information terminal, an audio player, a robot device, a digital camera, a video camera, a GPS device, a television receiver, a projector, and the like.

The invention is not limited to the above-described embodiments. Various modifications and variations may be made without departing from the spirit and scope of the invention. For example, the invention may be applied not only to drive the above-mentioned liquid crystal display panel, but also to drive an electroluminescent display device, a plasma display device, and the like. The liquid crystal panel is not limited to a high-temperature polysilicon liquid crystal panel, a low-temperature polysilicon liquid crystal panel, an amorphous silicon liquid crystal panel, and the like. Source drivers may be provided corresponding to the RGB color components, and each source driver may drive only the source lines corresponding to a single color component instead of causing one source driver to drive source lines of the RGB color components.

Some of the requirements of any claim of the invention may be omitted from a dependent claim that depends on that claim. Some of the requirements of any independent claim of the invention may be allowed to depend on any other independent claim,

Although only some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention.

What is claimed is:

1. A source driver that drives a source line of an electro-optical device, the source driver comprising:
an image data comparison circuit that compares K-bit (K is an integer equal to or larger than two) image data in a current drive period with preceding data corresponding to a preceding drive level; and
an amplifier circuit that drives the source line based on the image data with a first current drive capability, and then drives the source line based on the image data with a second current drive capability that is lower than the first current drive capability within a given drive period,
when the image data comparison circuit has detected that higher-order L bits (L<K, L is a natural number) of the image data coincide with higher-order L bits of the preceding data, the amplifier circuit driving the source line with the second current drive capability without driving the source line with the first current drive capability within the drive period; and
when the image data comparison circuit has detected that the higher-order L bits of the image data do not coincide with the higher-order L bits of the preceding data, the amplifier circuit driving the source line with the first current drive capability and then driving the source line with the second current drive capability within the drive period.

2. The source driver as defined in claim 1,
when the image data comparison circuit has detected that higher-order p bits (L<p<K, p is a natural number) of the image data coincide with higher-order p bits of the preceding data, the amplifier circuit driving the source line with the first current drive capability for a reduced period of time, and then driving the source line with the second current drive capability.

3. The source driver as defined in claim 1,
when performing multiplex drive that drives a plurality of the source lines based on time-division multiplexed image data, the image data comparison circuit comparing an average value of the time-division multiplexed image data with the preceding data instead of the image data;
when the image data comparison circuit has detected that the higher-order L bits of the image data coincide with the higher-order L bits of the preceding data, the amplifier circuit driving the source line with the second current drive capability without driving the source line with the first current drive capability within the drive period; and
when the image data comparison circuit has detected that the higher-order L bits of the average value do not coincide with the higher-order L bits of the preceding data, the amplifier circuit driving the source line with the first current drive capability and then driving the source line with the second current drive capability within the drive period.

4. The source driver as defined in claim 3,
when the image data comparison circuit has detected that higher-order p bits (L<p<K, p is a natural number) of the average value coincide with higher-order p bits of the preceding data, the amplifier circuit driving the source line with the first current drive capability for a reduced period of time, and then driving the source line with the second current drive capability.

5. The source driver as defined in claim 1,
the amplifier circuit driving the source line based on the image data with a third current drive capability that is lower than the first current drive capability and is higher than the second current drive capability; and
the amplifier circuit driving the source line based on the image data with the first current drive capability, then driving the source line based on the image data with the third current drive capability, and then driving the source line based on the image data with the second current drive capability.

6. The source driver as defined in claim 1,
the preceding data being data that corresponds to a precharge potential of the source line.

7. An electro-optical device comprising:
a plurality of gate lines;
a plurality of source lines;
a plurality of pixels, each of the plurality of pixels being specified by a corresponding gate line among the plurality of gate lines and a corresponding source line among the plurality of source lines;
a gate driver that scans the plurality of gate lines; and
the source driver as defined in claim 1 that drives the plurality of source lines.

8. An electro-optical device comprising the source driver as defined in claim 1.

9. A projection-type display device comprising:
the electro-optical device as defined in claim 7;
a light source that emits light that enters the electro-optical device; and
projection means that projects light emitted from the electro-optical device.

10. A projection-type display device comprising the source driver as defined in claim 1.

11. An electronic instrument comprising the electro-optical device as defined in claim 7.

12. An electronic instrument comprising:
the electro-optical device as defined in claim 7; and
means that supplies image data to the electro-optical device.

13. An electronic instrument comprising the source driver as defined in claim 1.
